(19) United States
(12) Patent Application Publication
(10) Pub. No.: US 2022/0202079 A1
(43) Pub. Date: Jun. 30, 2022

(54) SMOKING SUBSTITUTE COMPONENT

(71) Applicant: Nerudia Limited, Liverpool (GB)

(72) Inventors: Molly MCGUINNESS, Liverpool (GB); Pete Lomas, Liverpool (GB); Oliver Talbot, Liverpool (GB)

(21) Appl. No.: 17/698,542

(22) Filed: Mar. 18, 2022

Related U.S. Application Data
(63) Continuation of application No. PCT/EP20/76034, filed on Sep. 17, 2020.
Application No. PCT/EP20/76034 is a continuation of application No. PCT/EP20/76032, filed on Sep. 17, 2020.

(30) Foreign Application Priority Data
Sep. 20, 2019 (EP) 19198595.1
Sep. 20, 2019 (EP) 19198601.7

(51) Int. Cl. A24F 40/10; A24F 40/90; A24F 40/65; A24F 40/46; A24F 40/44; A24F 40/42; H02J 50/80; H02J 50/10; H01R 13/52; H05B 3/06

(52) U.S. Cl. CPC A24F 40/10; A24F 40/90; A24F 40/65; A24F 40/46; A24F 40/44; H05B 2203/016; H02J 50/80; H02J 50/10; H01R 13/521; H05B 3/06; A24F 40/42

(57) ABSTRACT

The present disclosure relates to an aerosol-delivery component, comprising: a vaporizer disposed in a vaporizing chamber; and an electrical contact for electrically connecting the vaporizer to a power supply, the contact extending through a base member of the component and into the vaporizing chamber. The component further comprises a sealing element configured to seal between the electrical contact and the base member.

### CROSS-REFERENCE TO RELATED APPLICATIONS/INCORPORATION BY REFERENCE STATEMENT

This application is a non-provisional application claiming benefit to the international application no. PCT/EP2020/076032 filed on Sep. 17, 2020, which claims priority to EP 19198601.7 filed on Sep. 20, 2019 and to the international application no. PCT/EP2020/076034 filed on Sep. 17, 2020, which claims priority to EP 19198595.1 filed on Sep. 20, 2019. The entire contents of each of the above-referenced applications are hereby incorporated herein by reference in their entirety.

### TECHNICAL FIELD

The present disclosure relates to an aerosol-delivery component, which may be a consumable for receipt in an aerosol-delivery device to form an aerosol-delivery system (e.g., a smoking substitute system).

The present disclosure further relates to a wireless charger for a smoking substitute device, as well as a smoking substitute kit including the wireless charger and a smoking substitute device.

### BACKGROUND

The smoking of tobacco is generally considered to expose a smoker to potentially harmful substances. It is generally thought that a significant amount of the potentially harmful substances are generated through the heat caused by the burning and/or combustion of the tobacco and the constituents of the burnt tobacco in the tobacco smoke itself.

Combustion of organic material such as tobacco is known to produce tar and other potentially harmful by-products. There have been proposed various smoking substitute systems in order to avoid the smoking of tobacco.

Such smoking substitute systems can form part of nicotine replacement therapies aimed at people who wish to stop smoking and overcome a dependence on nicotine.

Smoking substitute systems, which may also be known as electronic nicotine delivery systems, may comprise electronic systems that permit a user to simulate the act of smoking by producing an aerosol, also referred to as a “vapor”, which is drawn into the lungs through the mouth (inhaled) and then exhaled. The inhaled aerosol typically bears nicotine and/or flavorings without, or with fewer of, the odor and health risks associated with traditional smoking.

In general, smoking substitute systems are intended to provide a substitute for the rituals of smoking, whilst providing the user with a similar experience and satisfaction to those experienced with traditional smoking and tobacco products.

The popularity and use of smoking substitute systems has grown rapidly in the past few years. Although originally marketed as an aid to assist habitual smokers wishing to quit tobacco smoking, consumers are increasingly viewing smoking substitute systems as desirable lifestyle accessories. Some smoking substitute systems are designed to resemble a traditional cigarette and are cylindrical in form with a mouthpiece at one end. Other smoking substitute systems do not generally resemble a cigarette (for example, the smoking substitute device may have a generally box-like form).

There are a number of different categories of smoking substitute systems, each utilizing a different smoking substitute approach. A smoking substitute approach corresponds to the manner in which the substitute system operates for a user.

One approach for a smoking substitute system is the so-called “vaping” approach, in which a vaporizable liquid, typically referred to (and referred to herein) as “e-liquid”, is heated by a heater to produce an aerosol vapor which is inhaled by a user. An e-liquid typically includes a base liquid as well as nicotine and/or flavorings. The resulting vapor therefore typically contains nicotine and/or flavorings. The base liquid may include propylene glycol and/or vegetable glycerin.

A typical vaping smoking substitute system includes a mouthpiece, a power source (typically a battery), a tank or liquid reservoir for containing e-liquid, as well as a heater. In use, electrical energy is supplied from the power source to the heater, which heats the e- liquid to produce an aerosol (or “vapor”) which is inhaled by a user through the mouthpiece.

Vaping smoking substitute systems can be configured in a variety of ways. For example, there are “closed system” vaping smoking substitute systems which typically have a heater and a sealed tank which is pre-filled with e-liquid and is not intended to be refilled by an end user. One subset of closed system vaping smoking substitute systems include a device which includes the power source, wherein the device is configured to be physically and electrically coupled to a consumable component including the tank and the heater. In this way, when the tank of the consumable component has been emptied, the device can be reused by connecting it to a new consumable component. Another subset of closed system vaping smoking substitute systems are completely disposable, and intended for one-use only.

There are also “open system” vaping smoking substitute systems which typically have a tank that is configured to be refilled by a user, so the system can be used multiple times.

An example vaping smoking substitute system is the myblu™ e-cigarette. The myblu™ e cigarette is a closed system which includes a device and a consumable component. The device and consumable component are physically and electrically coupled together by pushing the consumable component into the device. The device includes a rechargeable battery. The consumable component includes a mouthpiece, a sealed tank which contains e-liquid, as well as a vaporizer, which for this system is a heating filament coiled around a portion of a wick which is partially immersed in the e-liquid. The system is activated when a microprocessor on board the device detects a user inhaling through the mouthpiece. When the system is activated, electrical energy is supplied from the power source to the vaporizer, which heats e-liquid from the tank to produce a vapor which is inhaled by a user through the mouthpiece.

Another example vaping smoking substitute system is the blu PROT™ e-cigarette. The blu PROT™ e cigarette is an open system which includes a device, a (refillable) tank, and a mouthpiece. The device and tank are physically and electrically coupled together by screwing one to the other. The mouthpiece and refillable tank are physically coupled together by screwing one into the other, and detaching the mouthpiece from the refillable tank allows the tank to be refilled with e-liquid. The system is activated by a button on the device. When the system is activated, electrical energy is supplied from the power source to a vaporizer, which heats e-liquid from the tank to produce a vapor which is inhaled by a user through the mouthpiece.

An alternative to the “vaping” approach is the so-called Heated Tobacco (“HT”) approach in which tobacco (rather than an e-liquid) is heated or warmed to release vapour. HT is also known as “heat not burn” (“HNB”). The tobacco may be leaf tobacco or reconstituted tobacco. In the HT approach the intention is that the tobacco is heated but not burned, i.e., the tobacco does not undergo combustion.

The heating, as opposed to burning, of the tobacco material is believed to cause fewer, or smaller quantities, of the more harmful compounds ordinarily produced during smoking. Consequently, the HT approach may reduce the odour and/or health risks that can arise through the burning, combustion and pyrolytic degradation of tobacco.

A typical HT smoking substitute system may include a device and a consumable. The consumable may include the tobacco material. The device and consumable may be configured to be physically coupled together. In use, heat may be imparted to the tobacco material by a heating element of the device, wherein airflow through the tobacco material causes components in the tobacco material to be released as vapor. A vapor may also be formed from a carrier in the tobacco material (this carrier may for example include propylene glycol and/or vegetable glycerin) and additionally volatile compounds released from the tobacco. The released vapor may be entrained in the airflow drawn through the tobacco.

As the vapor passes through the consumable (entrained in the airflow) from the location of vaporization to an outlet of the consumable (e.g., a mouthpiece), the vapor cools and condenses to form an aerosol for inhalation by the user. The aerosol may contain nicotine and/or flavor compounds.

Consumable components typically include various openings in the vaporizing chamber, e.g., to allow connection of electrical contacts to the vaporizer. It has been found that these openings may allow leakage of unvaporized e-liquid from the vaporizing chamber which may soil the user.

Because smoking substitute devices are often battery powered, they require regular charging. It is often desirable for a user to know when the smoking substitute device is fully charged, so that they are aware when to disconnect it and resume use. However, it is clearly undesirable for a user to have to wait with their device, or to keep checking to see whether it is fully-charged. The present disclosure has been devised in the light of the above considerations.

It is the object of the present disclosure to provide an improved aerosol delivery component.

### SUMMARY OF THE DISCLOSURE

First Mode: Aerosol-Delivery Component Having a Sealing Element Seals Between the Base Member and the Electrical Contact

According to a first aspect of the first mode there is a provided an aerosol-delivery component, comprising:
a vaporizer disposed in a vaporizing chamber;
an electrical contact for electrically connecting the vaporizer to a power supply, the contact extending through a base member of the component and into the vaporizing chamber; and
a sealing element configured to seal between the electrical contact and the base member.

Advantageously, the sealing element seals between the base member and the electrical contact, so as to prevent leakage of e-liquid from the vaporizing chamber or ingress of contaminants/moisture into the vaporizing chamber.

Optional features of the first mode will now be set out. These are applicable singly or in any combination with any aspect of the first mode.

Preferably, the base member accommodates the sealing element. Preferably, the sealing element is configured to directly engage the electrical contact to seal between the electrical contact and the base member.

The sealing element may be configured to at least partly define a wall of the vaporizing chamber.

The electrical contact may extend through the base member into the vaporizing chamber. The sealing element may be configured to form a seal between the vaporizing chamber and the base member where the electrical contact extends through the base member.

In some embodiments, the component further comprises a second electrical contact for electrically connecting the vaporizer to the power supply, the second contact extending through the base member of the component and into the vaporizing chamber. In these embodiments, the sealing element is further configured to seal between the second electrical contact and the base member.

The base member comprises a base slot through which the electrical contact extends. In embodiments with a second electrical contact, the base member may comprise a second base slot through which the second electrical contact extends.

The sealing element may be configured to directly engage the electrical contact/second electrical contact and the base member in order to form a seal therebetween, such that leakage of fluids from the vaporizing chamber, and/or ingress of moisture through the base slot/second base slot, is inhibited.

The electrical contact(s) preferably extend(s) through the base member (e.g., through the base slot(s)) in a longitudinal direction, i.e., in a direction aligned with the longitudinal axis of the component.

The base slot(s) may be transversely elongated, i.e., elongated in a direction perpendicular to the longitudinal axis of the component. For example, it/they may extend between substantially rectangular base slot opening(s).

The sealing element comprises a seal slot through which the electrical contact extends. In embodiments with a second electrical contact, the sealing element may comprise a second seal slot through which the second electrical contact extends.

The electrical contact(s) preferably extend(s) through the sealing element (e.g., through the seal slot(s)) in a longitudinal direction, i.e., in a direction aligned with the longitudinal axis of the component.

The seal slot(s) may be transversely elongated, i.e., elongated in a direction perpendicular to the longitudinal axis of the component. For example, it/they may extend between substantially rectangular seal slot opening(s).

The base slot and seal slot may be vertically/longitudinally aligned, i.e., the base slot and seal slot may overlay one another in the longitudinal direction of the component. The second base slot and second seal slot may be vertically/longitudinally aligned, i.e., the second base slot and second seal slot may overlay one another in the longitudinal direction of the component.

The dimensions (e.g., length and/or width in a plane perpendicular to the longitudinal axis of the component) of the seal slot/seal slot opening may be less than the dimensions of the base slot/base slot opening such that the seal slot forms a tight fit around the electrical contact. The dimensions (e.g., length and/or width in a plane perpendicular to the longitudinal axis of the component) of the second seal slot/seal slot opening may be less than the dimensions of the second base slot/base slot opening such that the second seal slot forms a tight fit around the second electrical contact.

The base member may comprise a lower transverse wall and the base slot(s) may be formed in the lower transverse wall. The base member may comprise opposing side walls upstanding from the lower transverse wall. The base member may comprise opposing front and rear walls upstanding from the lower transverse wall. The opposing upstanding side walls and upstanding front/rear walls may at least partly define the side walls and front/rear walls of the vaporizing chamber.

The base member may further comprise an upper transverse wall which is substantially parallel to the lower transverse wall and which defines an upper wall of the vaporizing chamber. The base member may comprise opposing side walls depending downwards from the upper transverse wall. The base member may comprise opposing front and rear walls depending downwards from the upper transverse wall. The opposing depending side walls and depending front/rear walls may at least partly define the side walls and front/rear walls of the vaporizing chamber.

The depending side walls and depending front/rear walls may cooperate with the upstanding side walls and upstanding front/rear walls to partially seal the vaporizing chamber. For example, the depending walls may form a sleeve arrangement radially outwards of the upstanding walls.

The lower transverse wall of the base member may comprise a recess for housing the sealing element. The lower transverse wall/sealing element (i.e., an upper surface of the sealing element) may define the lower transverse wall of the vaporizing chamber.

The sealing element has a length, a width and a thickness. The sealing element may be substantially cuboid. The thickness of the sealing element extends along the longitudinal axis of the consumable component. The cross-sectional area of the sealing element in the transverse plane may be substantially rectangular.

The upper surface of the sealing element (facing the vaporizing chamber) may comprise an elongate channel which may have a semi-cylindrical profile. The elongate channel may extend between the front and rear walls of the base member/vaporizing chamber.

The vaporizer may comprise a heating filament mounted on (e.g., coiled around) a substrate, e.g., a porous substrate or wick. The substrate/wick may be elongated and the axis of the elongate substrate/wick may be parallel to and vertically spaced above the channel.

The axis of the channel (and substrate/wick) may be perpendicular to the transverse extension of the base/seal slot opening(s).

Where there are first and second base/seal slot openings the first base/seal slot openings may be provided on an opposing side of the channel to the second base/seal slots. The first base/seal slot openings and second base/seal slot openings may be off set in a front to rear direction, e.g., the first base/seal slot openings may be proximal the rear wall of the base member/vaporizing chamber and the second base/seal slot openings may be proximal the front wall of the base member/vaporizing chamber (or vice versa).

In some embodiments, the sealing element is formed of a heat resistant and/or electrically insulating material, e.g., it may be at least partially formed of silicone.

The component comprises an airflow path that extends from an air inlet to an air outlet. The air outlet is provided in a mouthpiece portion, e.g., a mouthpiece portion of a component housing.

The air outlet/mouthpiece portion may be provided at a first lateral end of the housing. The housing comprises the base member at the opposing lateral end. The base member is received into an open (e.g., lower) end of the housing.

The air flow path passes the vaporizer between the air inlet to the air outlet. The vaporizer is housed in the vaporizing chamber.

The air flow path may comprise a first portion extending from the air inlet towards the base member of the housing (and away from the mouthpiece portion), e.g., in a substantially longitudinal direction.

The airflow path may comprise a second portion which passes the vaporizer, e.g., passes through the vaporizing chamber.

The airflow path may comprise a third portion extending longitudinally from the second portion to the air outlet (formed in the mouthpiece portion of the housing).

In this respect, a user may draw air into and along the airflow path by inhaling at the air outlet (i.e., using the mouthpiece portion).

The third portion of the airflow path may be substantially parallel to the first portion of the airflow path. The third portion of the airflow path may be longer (i.e., in a longitudinal direction) than the first airflow path. The second portion of the airflow path may be a transverse portion, i.e., extending substantially perpendicular to the first and/or third portions of the airflow path.

The airflow path may be generally U-shaped (the first and third portions forming stems of the “U” and the second portion forming the base of the “U”). In this respect, the second portion of the airflow path may connect the first and third portions of the airflow path. The airflow path may comprise at least two turns (e.g., each of around 90°) between the inlet and the vaporizer. The airflow path may comprise at least one turn between the vaporizer and the outlet.

The component may comprise a tank for housing an aerosol precursor (e.g., a liquid aerosol precursor). The aerosol precursor may comprise an e-liquid, for example, comprising a base liquid and, e.g., nicotine. The base liquid may include propylene glycol and/or vegetable glycerin. Hence, the component may be a vaping smoking substitute component.

A vent may be provided in the upper transverse wall of the base member for the flow of air into the tank (i.e., so as to allow for pressure equalization in the tank).

The second portion of the airflow path may be disposed between (i.e., longitudinally between) the upper and lower transverse walls of the base member, i.e., within the vaporizing chamber. The tank may be disposed between (in a transverse direction) the first and the third portions of the airflow path.

References to “downstream” in relation to the air flow path are intended to refer to the direction towards the air outlet/mouthpiece portion. Thus, the second and third portions of the air flow path are downstream of the first portion of the air flow path. Conversely, references to “upstream” are intended to refer to the direction towards the air inlet. Thus, the first portion of the airflow path (and the air inlet) is upstream of the second/third portions of the air flow path (and the air outlet/mouthpiece portion).

As discussed above, the component housing comprises the mouthpiece portion (with the air outlet) at a first lateral end and the base member at the opposing lateral end.

The housing further comprises one or more side walls (e.g., laterally opposed first and second side walls) extending longitudinally from the mouthpiece portion to the base member.

The air inlet may be provided in the first side wall, longitudinally spaced (towards the mouthpiece portion) from the base member.

The air inlet may be longitudinally spaced from the base member/lower end of the housing by a distance that is greater than 8 mm. The distance may be greater than 10 mm, or, e.g., greater than 13 mm.

The housing may further comprise opposing front and rear walls spaced by the laterally opposed first and second side walls. The distance between the first and second side walls of the housing may define a width of the housing. The distance between the front and rear walls may define a depth of the housing. The width of the housing may be greater than the depth of the housing.

The length of the housing may be greater than the width of the housing. The depth of the housing may be smaller than each of the width and the length.

The first portion of the airflow path may be defined within an inlet passage between a wall of the tank and a wall of the housing. The wall of the housing partly defining the first portion of the airflow path may be the first side wall of the housing. The wall of the tank defining the first portion of the airflow path may be a first tank wall. Thus, the first portion of the airflow path/inlet passage may be defined between the first tank wall and the first side wall. The first side wall and the first tank wall may be integrally formed with one another.

The third portion of the airflow path may be defined within an outlet passage between a wall of the tank and a wall of the housing. The wall of the housing partly defining the third portion of the airflow path may be the second side wall of the housing. The wall of the tank defining the third portion of the airflow path may be a second tank wall. Thus, the third portion of the airflow path/outlet passage may be defined between the second tank wall and the second side wall. The second side wall and the second tank wall may be integrally formed with one another.

All of the first side wall, second side wall, first tank wall and second tank wall may all be integrally formed and may additionally be integrally formed with the mouthpiece portion. In that way, the component may be easily manufactured using injection molding.

References to “upper”, “lower”, “above” or “below” are intended to refer to the component when in an upright/vertical orientation, i.e., with elongate (longitudinal/length) axis of the component vertically aligned and with the mouthpiece portion vertically uppermost and the base portion lowermost.

The first and second tank walls may be spaced from one another so as to define the tank therebetween. The first and second tank walls may extend longitudinally from the mouthpiece portion towards the base member of the housing. The first and second tank walls may be substantially parallel. Each of the first and second tank walls may extend between (and span) the front and rear walls of the housing.

Each of the first and second tank walls may extend from the mouthpiece portion (i.e., internally in the housing). Each of the first and second tank walls may be integrally formed with the mouthpiece portion.

The tank may be partly defined by a wall of the housing (e.g., the front or rear wall). At least a portion of one of the walls defining the tank may be translucent or transparent. That is, the tank may comprise a window to allow a user to visually assess the quantity of e-liquid in the tank. The tank may be referred to as a “clearomizer” if it includes a window, or a “cartomizer” if it does not.

As discussed above, the air flow path passes the vaporizer between the air inlet to the air outlet. The vaporizer may comprise a heating element for heating the wick.

The wick may extend across the second (transverse) portion of the air flow path. The wick may be oriented so as to extend in a direction from the front wall to the rear wall of the vaporizing chamber, i.e., it may be oriented in the direction of the depth dimension of the component. Thus, the wick may extend in a direction perpendicular to the direction of air flow in the second portion of the air flow path.

As discussed above, the substrate/wick may extend between the front/rear walls of the base member/vaporizing chamber. The front and rear walls of the base member/vaporizing chamber may separate (i.e., partially separate) the vaporizing chamber from the tank. The front/rear walls may each comprise a respective opening through which a respective end of the substrate/wick projects such that the wick is fluid communication with aerosol precursor/e-liquid in the tank. In this way a central portion of the wick may be exposed to air in the (second portion of the) airflow path and end portions of the wick may be in contact with aerosol precursor/e-liquid stored in the tank. Thus, aerosol precursor may be drawn (e.g., by capillary action) along the wick, from the tank to the exposed portion of the wick.

The wick may have an elongate shape. The wick may be cylindrical and preferably has an axis extending parallel to the axis of the elongate channel provided in the upper surface of the sealing element. The heating element may be in the form of a filament wound about the wick (e.g., the filament may extend helically about the wick). The filament may be wound about the exposed portion of the wick (i.e., the portion of the wick extending across the airflow path). The heating element may be electrically connectable (or connected) to a power source via the first/second electrical contacts. Thus, in operation, the power source may supply electricity to (i.e., apply a voltage across) the heating element so as to heat the heating element. This may cause liquid stored in the wick (i.e., drawn from the tank) to be heated so as to form a vapor and become entrained in fluid flowing along the airflow path. This vapor may subsequently cool to form an aerosol in the airflow path (e.g., the third portion of the airflow path).

In a second aspect of the first mode there is provided an aerosol-delivery system (e.g., a smoking substitute system) comprising a component according to the first aspect of the first mode and an aerosol-delivery (e.g., smoking substitute) device.

The component may be an aerosol-delivery (e.g., a smoking substitute) consumable, i.e., in some embodiments the component may be a consumable component for engagement with the aerosol-delivery (e.g., a smoking substitute) device to form the aerosol-delivery (e.g., s smoking substitute) system.

The device may be configured to receive the consumable component. For example, the device and the consumable component may be configured to be physically coupled together. For example, the consumable component may be at least partially received in a recess of the device, such that there is snap engagement between the device and the consumable component. Alternatively, the device and the consumable component may be physically coupled together by screwing one onto the other, or through a bayonet fitting.

Thus, the consumable component may comprise one or more engagement portions for engaging with the device. In this way, one end of the consumable component (i.e., the inlet end) may be coupled with the device, while an opposing end (i.e., the outlet end) of the consumable component may define a mouthpiece.

The consumable component may comprise an electrical interface for interfacing with a corresponding electrical interface of the device. One or both of the electrical interfaces may include one or more electrical contacts. Thus, when the device is engaged with the consumable component, the electrical interface may be configured to transfer electrical power from the power source to a heating element of the consumable component. The electrical interface may also be used to identify the consumable component from a list of known types. The electrical interface may additionally or alternatively be used to identify when the consumable component is connected to the device.

The device may alternatively or additionally be able to detect information about the consumable component via an RFID reader, a barcode or QR code reader. This interface may be able to identify a characteristic (e.g., a type) of the consumable. In this respect, the consumable component may include any one or more of an RFID chip, a barcode or QR code, or memory within which is an identifier and which can be interrogated via the interface.

In other embodiments, the component may be integrally formed with the aerosol-delivery (e.g., a smoking substitute) device to form the aerosol-delivery (e.g., s smoking substitute) system.

In such embodiments, the aerosol former (e.g., e-liquid) may be replenished by re- filling a tank that is integral with the device (rather than replacing the consumable). Access to the tank (for re-filling of the e-liquid) may be provided via, e.g., an opening to the tank that is sealable with a closure (e.g., a cap).

Further features of the device are described below. These are applicable to both the device for receiving a consumable component and to the device integral with the component.

The device may comprise a power source. The device may comprise a controller.

A memory may be provided and may be operatively connected to the controller. The memory may include non-volatile memory. The memory may include instructions which, when implemented, cause the controller to perform certain tasks or steps of a method. The device may comprise a wireless interface, which may be configured to communicate wirelessly with another device, for example a mobile device, e.g., via Bluetooth®. To this end, the wireless interface could include a Bluetooth® antenna. Other wireless communication interfaces, e.g., WIFI®, are also possible. The wireless interface may also be configured to communicate wirelessly with a remote server.

An airflow (i.e., puff) sensor may be provided that is configured to detect a puff (i.e., inhalation from a user). The airflow sensor may be operatively connected to the controller so as to be able to provide a signal to the controller that is indicative of a puff state (i.e., puffing or not puffing). The airflow sensor may, for example, be in the form of a pressure sensor or an acoustic sensor. The controller may control power supply to a heating element in response to airflow detection by the sensor. The control may be in the form of activation of the heating element in response to a detected airflow. The airflow sensor may form part of the device.

In a third aspect of the first mode there is provided a method of using the aerosol- delivery (e.g., smoking substitute) consumable component according to the first aspect of the first mode, the method comprising engaging the consumable component with an aerosol- delivery (e.g., smoking substitute) device (as described above) having a power source so as to electrically connect the power source to the consumable component (i.e., to the vaporizer of the consumable component).

Second Mode: Wireless Charger for a Smoking Substitute Device

In order to address the above, in broad terms a second mode of the present disclosure provides a wireless charger which is able to receive charging status information from the smoking substitute device which it is currently charging, and then to transmit that information to an external location, from which it may be obtained by a user. In this way, the user can remotely receive information about the charge status of the smoking substitute device without having to keep returning to the device. Specifically, this is achieved in the provision of a first aspect of the second mode, namely a wireless charger for a smoking substitute device, the wireless charger including: a data receiving module for receiving telemetry data from the smoking substitute device; a wireless transmission module for transmitting the telemetry data to an external location. Having the wireless transmissions device as part of a wireless charger reduces the number of components required to achieve the advantage of the second mode. The wireless charger of the second mode enables transfer of telemetry data between the smoking substitute device and the external device without the need for direct syncing between the smoking substitute device and the external location. In other words, if a user has not synced the smoking substitute device with an external device such as a smartphone or tablet for a long time, telemetry data can still be recorded wirelessly.

In the present application, the term “wireless charger” refers to a charger for a smoking substitute device which transfers power to a power source of the smoking substitute device (e.g., a rechargeable battery) without any direct electrical contact. In preferred embodiments, the wireless charger is configured to charge the smoking substitute device using electromagnetic induction, and accordingly may include a transmitter coil. It should be stressed that the transmitter coil is separate from the wireless transmission means. An alternating electromagnetic field may be generated in the transmitter coil, which the then able to induce a current in a receiver coil in the smoking substitute device. The disclosure is not directed towards the mechanics of the wireless charging, but it should suffice to note that there are other methods of wireless charging available, of which the skilled person will be aware.

The wireless charger preferably includes a charging region, wherein when the smoking substitute device is placed in the charging region, the transmitter coil of the wireless charger and the receiver coil of the smoking substitute device are relatively positioned so that a current in the transmitter coil is able to induce a current in the receiver coil, thereby charging the smoking substitute device.

In some embodiments of the second mode, the charging region may include a flat surface on which the smoking substitute device may be placed so that the receiver coil in the smoking substitute device is aligned with the transmitter coil in the wireless charger. Alternatively, the charging region may include a recess, for example a cylindrical or substantially cylindrical recess configured to receive the smoking substitute device. In such cases, the transmitter coil may be located around the circumference (or outer perimeter) of the recess. The coil could either be on the inner surface of the recess, or it could be embedded within the cylindrical wall of the recess, spaced from the surface. In such cases, the corresponding receiver coil of the smoking substitute device may be located at a portion of the smoking substitute device which is to be inserted into the recess. Conversely, the charging region may include a cylindrical or substantially cylindrical projection, and the transmitter coil could be located around the circumference of the outer surface of the projection. Alternatively, the transmitter coil could be embedded within the wall of the projection, spaced from the surface. In such arrangements, the smoking substitute device may include a corresponding recess configured to receive the projection of the wireless charger.

The wireless charger may be in the form of a power pack, i.e., a rechargeable module which does not need to be connected to, e.g., mains electricity to charge the smoking substitute device. Alternatively, the wireless charger may be in the form of a more conventional charger, which must be plugged in to charge the smoking substitute device.

In some embodiments of the second mode, the data receiving module may be configured to receive the telemetry data from the smoking substitute device, for example using Bluetooth, or specifically Bluetooth Low Energy. Similarly, the wireless transmission module may be configured to transmit the telemetry data to an external device, for example using Bluetooth, or specifically Bluetooth Low Energy. Alternatively, in other embodiments of the second mode, the data receiving module may be configured to receive the telemetry data from the smoking substitute device, for example across a cellular network. Similarly, the wireless transmission module may be configured to transmit the telemetry data to an external device, for example across a cellular network. The skilled person will appreciate that any compatible combination of these different transmission mechanisms may apply to embodiments of the first aspect of the second mode. Alternatively, in other embodiments of the second mode, the data receiving module may be configured to receive the telemetry data from the smoking substitute device, for example across a Wi-Fi network. Similarly, the wireless transmission module may be configured to transmit the telemetry data to an external device, for example across a Wi-Fi network.

In some embodiments of the second mode, the external location may be an external device such as a smartphone, tablet, or computer. Alternatively, the alternative location may be a cloud storage facility. In preferred embodiments, for example, the wireless transmission module of the wireless charger may be configured to transmit the telemetry data to the cloud across a Wi-Fi network.

In some embodiments of the second mode, the data received from the smoking substitute device may include a request, for example a charging request, i.e. a request to begin charging. In such cases, the wireless charger may be configured to begin charging of the smoking substitute device only in response to the data receiving module receiving a charge request. In this way, charging of the smoking substitute device may only take place when a user has sent a charging request, e.g., by pressing a button on the smoking substitute device. This is particularly useful in the case of power pack-style wireless chargers, as it can ensure that the energy stored on the power pack is not wasted when the user does not wish to charge the smoking substitute device.

In some cases, the wireless charger may be configured to transmit data relating to the strength of the charging connection to the smoking substitute device, and/or the wireless charger may be configured to receive data relating to the strength of the charging connection from the smoking substitute device. The data relating to the strength of the charging connection is preferably numerical data, for example a percentage, or an absolute value. The wireless charger may be configured to adjust its charging power based on the strength of the charging connection. Specifically, the wireless charger may be configured to detect a change in the strength of the charging connection, and to adjust the charging power in response to the detection of the change. If the strength of the charging connection decreases, the wireless charger may be configured to increase the charging power, and if the strength of the charging connection increases, the wireless charger may be configured to decrease the charging power. In this way, the wireless charger can operate the most energy efficiently. It should be noted that “the strength of the charging connection” refers to the wireless connection between the smoking substitute device and the wireless, and may for example be based on the alignment of coils within the smoking substitute device and wireless charger. It is not used here to refer to the strength of the connection by which data is transmitter and received.

The wireless charger may include a memory which is configured to store the telemetry data received from the smoking substitute device. In this way, the telemetry data may be stored on the wireless charger before being transmitted to the external location by the wireless transmission module. This is advantageous in situations where, for example, there is no Bluetooth or Wi-Fi connection between the transmission module and external location; the data to be transmitted can be stored on the memory and then transmitted by the wireless transmission module to the external location at a later time. The memory may also be configured to act as a buffer, for example when the rate at which telemetry data is received from the smoking substitute device is greater than the rate at which telemetry data can be transferred to the external location. The wireless charger may also include a processor configured to perform processing on the telemetry data.

The telemetry data received from the smoking substitute device may include the information about the charge status of the smoking substitute. The information about charge status may include one or more of the following: the amount of battery life remaining in the battery of the smoking substitute device (expressed as e.g. a percentage, an estimated amount of time remaining, an estimated time at which the battery will run out, or a number of puffs remaining), an estimate of the amount of time until the battery of the smoking substitute device will be fully charged, an indication of whether the wireless charger is currently charging the smoking substitute device or not, and an indication that the battery is fully charged. In some embodiments, the wireless charger itself may further include a display which is configured to display the information (or a representation thereof) received from the smoking substitute device, which may include information about the charge status of the device. The display may be in the form of a screen, or a plurality of lights.

In addition to information about the charge status of the smoking substitute device, the telemetry data received from the smoking substitute device may also include information about the usage of the smoking substitute device. More specifically:

(1) The information relating to usage of the smoking substitute device may include statistics relating to usage of the smoking substitute device, e.g., which could then be presented to a user via the computing device (alternatively, usage statistics could be calculated at the computing device based on information received from the smoking substitute device).

(2) The information relating to usage of the smoking substitute device may include information relating to or describing a number of times the smoking substitute device has been activated. This information could for example include a number of times the device has been activated starting from a first activation by a user, and/or a number of times the device has been activated since the device was last charged.

(3) The information relating to usage of the smoking substitute device may include information relating to or describing one or more lengths of time for which the smoking substitute device has been activated. This information could for example include an average length of time the smoking substitute device has been activated by a user (per activation), and/or a total length of time the smoking substitute device has been activated by a user (over all activations).

(4) The information relating to usage of the smoking substitute device may include information relating to or describing one or more flavors used with the smoking substitute device. This information could for example include an indication of the/each flavor of consumable material (e.g., e-liquid or tobacco) used with the smoking substitute device.

(5) If the smoking substitute device includes a main body for use with a consumable, the information relating to usage information may include information associated with the consumable, e.g., information relating to or describing one or more flavors of consumable used with the smoking substitute device. The information could include an indication of the/each flavor of consumable liquid in the consumables that have been used with the smoking substitute device.

The telemetry data which is transmitted from the wireless transmission module to the external location may include the same information. It will be appreciated that such information is useful for the user of the smoking substitute device/external device. As such, in some embodiments of the second mode, in addition to this information or the charge status, the telemetry data which is transmitted from the wireless transmission module to the external device may include a trigger, the trigger being configured to cause the external device to generate and/or display a notification relating to the information.

In some embodiments of the second mode, the data receiving module may be configured only to receive telemetry data from the smoking substitute device when the smoking substitute device is being charged by the wireless charger. In this way, the battery life of the smoking substitute device may be preserved by ensuring that it need only transmit telemetry data to the wireless charger when it is being charged, i.e., when it is “plugged in”. Alternatively, in some cases, the wireless charger may be configured automatically to receive the telemetry data when the smoking substitute device is being charged.

Another aspect of the second mode may provide a smoking substitute kit including a smoking substitute device, and a wireless charger according to the previous aspect of the second mode, wherein the wireless charger is configured to charge the smoking substitute device when the smoking substitute device is in proximity with the wireless charger. The smoking substitute device preferably includes a receiver coil. Then, when the smoking substitute device is placed in a charging region of the wireless charger, the transmitter coil of the wireless charger and the receiver coil of the smoking substitute device are relatively positioned so that a current in the transmitter coil is able to induce a current in the receiver coil, thereby charging the smoking substitute device.

In embodiments in which the charging region of the wireless charger includes a flat surface, the receiver coil of the smoking substitute device is preferably located such that when the smoking substitute device is placed on the flat surface, the receiver coil in the smoking substitute device is aligned with the transmitter coil in the wireless charger. When the charging region of the wireless charger includes a recess as discussed earlier in this application, the corresponding receiver coil of the smoking substitute device is preferably located at or in a portion of the smoking substitute device which is shaped or configured to be inserted into the recess. In embodiments in which the charging region of the wireless charger includes a cylindrical or substantially cylindrical projection as discussed earlier in this application, the smoking substitute device may include a corresponding recess configured to receive the projection of the wireless charger, wherein the receiver coil of the smoking substitute device is located around the circumference of the recess, or is embedded in the wall surrounding the recess.

The smoking substitute device preferably includes a wireless transmission module configured to transmit telemetry data to the data receiving module of the wireless charger, wherein the transmitted telemetry data may include information about a charge status of the smoking substitute device. The wireless transmission module of the smoking substitute device may be configured to transmit telemetry data to the data receiving module of the wireless charger using one of: Bluetooth (e.g., Bluetooth Low Energy), a cellular network, or a Wi-Fi network.

In some embodiments of the second mode, the data receiving module may be configured to receive telemetry data from the smoking substitute device, for example using Bluetooth, or specifically Bluetooth Low Energy. Similarly, the wireless transmission module may be configured to transmit telemetry data to an external device, for example using Bluetooth, or specifically Bluetooth Low Energy. Alternatively, in other embodiments of the second mode of the present disclosure, the data receiving module may be configured to receive telemetry data from the smoking substitute device, for example across a cellular network. Similarly, the wireless transmission module may be configured to transmit telemetry data to an external device, for example across a cellular network. The skilled person will appreciate that any compatible combination of these different transmission mechanisms may apply to embodiments of the first aspect of the second mode. Alternatively, in other embodiments of the of the second mode, the data receiving module may be configured to receive telemetry data from the smoking substitute device, for example across a Wi-Fi network. Similarly, the wireless transmission module may be configured to transmit telemetry data to an external device, for example across a Wi-Fi network.

The wireless transmission module of the smoking substitute device may be configured to transmit a request, for example a charging request, i.e., a request to begin charging, to the data receiving module of the wireless charger.

The wireless transmission module of the smoking substitute device may be configured to transmit information about the charge status of the smoking substitute. The information about charge status may include one or more of the following: the amount of battery life remaining in the battery of the smoking substitute device (expressed as, e.g., a percentage, an estimated amount of time remaining, an estimated time at which the battery will run out, or a number of puffs remaining), an estimate of the amount of time until the battery of the smoking substitute device will be fully charged, an indication of whether the wireless charger is currently charging the smoking substitute device or not.

In addition to information about the charge status of the smoking substitute device, the wireless transmission module of the smoking substitute device may be configured to transmit data include information about the usage of the smoking substitute device, a non- exhaustive list of examples of which were set out earlier in this application.

In order to conserve the battery life of the smoking substitute device, the wireless transmission module of the smoking substitute device may be configured only to transmit data to the data receiving module of the wireless charger when the smoking substitute device is being charged by the wireless charger. Alternatively, in other cases, the smoking substitute device may be configured to transmit telemetry data to the data receiving module of the wireless charger automatically when the smoking substitute device is being charged.

Further optional features of the smoking substitute device are set out below in detail.

The smoking substitute device may comprise a passage for fluid flow therethrough. The passage may extend through (at least a portion of) the smoking substitute device, between openings that may define an inlet and an outlet of the passage. The outlet may be at a mouthpiece of the smoking substitute device. In this respect, a user may draw fluid (e.g., air) into and through the passage by inhaling at the outlet (i.e., using the mouthpiece).

The device may comprise a tank (reservoir) for containing a vaporizable liquid (e.g., an e-liquid). The e-liquid may, for example, comprise a base liquid and, e.g., nicotine. The base liquid may include propylene glycol and/or vegetable glycerin.

The tank may be defined by a tank housing. At least a portion of the tank housing may be translucent. For example, the tank housing may comprise a window to allow a user to visually assess the quantity of e-liquid in the tank. The tank may be referred to as a “clearomizer” if it includes a window, or a “cartomizer” if it does not. The passage may extend longitudinally within the tank and a passage wall may define the inner wall of the tank. In this respect, the tank may surround the passage, e.g., the tank may be annular. The passage wall may comprise longitudinal ribs extending therealong. These ribs may provide support to the passage wall. The ribs may extend for the full length of the passage wall. The ribs may project (e.g., radially outwardly) into the tank.

The smoking substitute device may comprise a vaporizer. The vaporizer may comprise a wick. The vaporizer may further comprise a heater. The wick may comprise a porous material. A portion of the wick may be exposed to fluid flow in the passage. The wick may also comprise one or more portions in contact with liquid stored in the reservoir. For example, opposing ends of the wick may protrude into the reservoir and a central portion (between the ends) may extend across the passage so as to be exposed to fluid flow in the passage. Thus, fluid may be drawn (e.g., by capillary action) along the wick, from the reservoir to the exposed portion of the wick.

The heater may comprise a heating element, which may be in the form of a filament wound about the wick (e.g., the filament may extend helically about the wick). The filament may be wound about the exposed portion of the wick. The heating element may be electrically connected (or connectable) to a power source. Thus, in operation, the power source may supply electricity to (i.e., apply a voltage across) the heating element so as to heat the heating element. This may cause liquid stored in the wick (i.e., drawn from the tank) to be heated so as to form a vapor and become entrained in fluid flowing through the passage. This vapor may subsequently cool to form an aerosol in the passage.

The device of the second mode may be in the form of a consumable. The consumable may be configured for engagement with a main body (i.e., so as to form a smoking substitute system). For example, the consumable may comprise components of the system that are disposable, and the main body may comprise non-disposable or non-consumable components (e.g., power supply, controller, sensor, etc.) that facilitate the delivery of aerosol by the consumable. In such an embodiment, the aerosol former (e.g., e-liquid) may be replenished by replacing a used consumable with an unused consumable.

In light of this, it should be appreciated that some of the features described herein as being part of the smoking substitute device may alternatively form part of a main body for engagement with the consumable.

The main body and the consumable may be configured to be physically coupled together. For example, the consumable may be at least partially received in a recess of the main body, such that there is snap engagement between the main body and the consumable. Alternatively, the main body and the consumable may be physically coupled together by screwing one onto the other, or through a bayonet fitting.

Thus, the consumable may comprise one or more engagement portions for engaging with a main body. In this way, one end of the consumable (i.e., the inlet end) may be coupled with the main body, whilst an opposing end (i.e., the outlet end) of the consumable may define a mouthpiece.

The main body or the consumable may comprise a power source or be connectable to a power source. The power source may be electrically connected (or connectable) to the heater. The power source may be a battery (e.g., a rechargeable battery). An external electrical connector in the form of, e.g., a USB port may be provided for recharging this battery.

The consumable may comprise an electrical interface for interfacing with a corresponding electrical interface of the main body. One or both of the electrical interfaces may include one or more electrical contacts. Thus, when the main body is engaged with the consumable, the electrical interface may be configured to transfer electrical power from the power source to a heater of the consumable. The electrical interface may also be used to identify the consumable from a list of known types. The electrical interface may additionally or alternatively be used to identify when the consumable is connected to the main body.

The main body may alternatively or additionally be able to detect information about the consumable via an RFID reader, a barcode or QR code reader. This interface may be able to identify a characteristic (e.g., a type) of the consumable. In this respect, the consumable may include any one or more of an RFID chip, a barcode or QR code, or memory within which is an identifier and which can be interrogated via the interface.

The consumable or main body may comprise a controller, which may include a microprocessor. The controller may be configured to control the supply of power from the power source to the heater (e.g., via the electrical contacts). A memory may be provided and may be operatively connected to the controller. The memory may include non-volatile memory. The memory may include instructions which, when implemented, cause the controller to perform certain tasks or steps of a method.

The consumable or main body may comprise a wireless interface, which may be configured to communicate wirelessly with another device, for example a mobile device, e.g., via Bluetooth®. To this end, the wireless interface could include a Bluetooth® antenna. Other wireless communication interfaces, e.g., WIFI®, are also possible. The wireless interface may also be configured to communicate wirelessly with a remote server.

An airflow (i.e., puff) sensor may be provided that is configured to detect a puff (i.e., inhalation from a user). The airflow sensor may be operatively connected to the controller so as to be able to provide a signal to the controller that is indicative of a puff state (i.e., puffing or not puffing). The airflow sensor may, for example, be in the form of a pressure sensor or an acoustic sensor. The controller may control power supply to the heater in response to airflow detection by the sensor. The control may be in the form of activation of the heater in response to a detected airflow. The airflow sensor may form part of the consumable or the main body.

In an alternative embodiment the device may be a non-consumable device in which an aerosol former (e.g., e-liquid) of the device may be replenished by re-filling the tank of the device (rather than replacing the consumable). In this embodiment, the consumable described above may instead be a non-consumable component that is integral with the main body. Thus, the device may comprise the features of the main body described above. In this embodiment, the only consumable portion may be e-liquid contained in the tank of the device. Access to the tank (for re-filling of the e-liquid) may be provided via, e.g., an opening to the tank that is sealable with a closure (e.g., a cap).

The device may be a smoking substitute device (e.g., an e-cigarette device) and, when in the form of a consumable, may be a smoking substitute consumable (e.g., an e-cigarette consumable).

The disclosure includes the combination of the aspects and preferred features of the various modes described herein except where such a combination is clearly impermissible or expressly avoided.

### BRIEF DESCRIPTION OF THE DRAWINGS

So that further aspects and features thereof may be appreciated, embodiments will now be discussed in further detail with reference to the accompanying figures, in which:

FIG. 1A is a front schematic view of a smoking substitute system of the first mode;

FIG. 1B is a front schematic view of a device of the system of the first mode;

FIG. 1C is a front schematic view of a consumable of the system of the first mode;

FIG. 2A is a schematic of the components of the device of the first mode;

FIG. 2B is a schematic of the components of the consumable of the first mode;

FIG. 3A is a front section view of the consumable of the first mode;

FIG. 3B is a perspective section view of the consumable of the first mode;

FIG. 3C is a side section view of the consumable of the first mode;

FIG. 4A is a perspective section view of a vaporizing chamber of the component of the first mode;

FIG. 4B is a side section view of the vaporizing chamber of the first mode;

FIG. 5A is a perspective view of a sealing element of the component of the first mode;

FIG. 5B is a bottom view of the sealing element of the first mode;

FIG. 6A is a front schematic view of a smoking substitute system of the second mode;

FIG. 6B is a front schematic view of a main body of the system of the second mode;

FIG. 6C is a front schematic view of a consumable of the system of the second mode;

FIG. 7A is a schematic of the components of the main body of the second mode;

FIG. 7B is a schematic of the components of the consumable of the second mode;

FIG. 8 is a section view of the consumable of the second mode; and

FIG. 9 is a system diagram of a smoking substitute system of the second mode.

### DETAILED DESCRIPTION OF THE DISCLOSURE

First Mode: Aerosol-Delivery Component Having a Sealing Element Seals Between the Base Member and the Electrical Contact

Aspects and embodiments will now be discussed with reference to the accompanying figures. Further aspects and embodiments will be apparent to those skilled in the art.

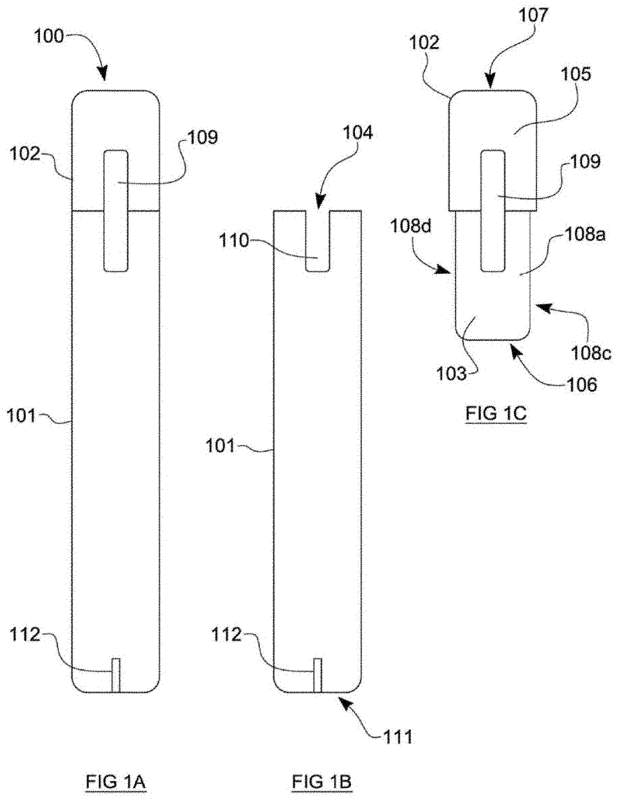

FIG. 1A shows a smoking substitute system 100. In this example, the smoking substitute system 100 includes a device 101 and an aerosol delivery consumable component 102. The consumable component 102 may alternatively be referred to as a “pod”, “cartridge” or “cartomizer”. It should be appreciated that in other examples (i.e., open systems), the device may be integral with the component. In such systems, a tank of the aerosol delivery component may be accessible for refilling the system.

In this example, the smoking substitute system 100 is a closed system vaping system, wherein the consumable component 102 includes a sealed tank 103 and is intended for single-use only. The consumable component 102 is removably engageable with the device 101 (i.e., for removal and replacement). FIG. 1A shows the smoking substitute system 100 with the device 101 physically coupled to the consumable component 102, FIG. 1B shows the device 101 of the smoking substitute system 100 without the consumable component 102, and FIG. 1C shows the consumable component 102 of the smoking substitute system 100 without the device 101.

The device 101 and the consumable component 102 are configured to be physically coupled together by pushing the consumable component 102 into a cavity at an upper end 104 of the device 101, such that there is an interference fit between the device 101 and the consumable component 102. In other examples, the device 101 and the consumable component 102 may be coupled by screwing one onto the other, or through a bayonet fitting.

The consumable component 102 comprises a housing 105 having a base portion 106 (at a lower end), a mouthpiece 107 (at an upper end), and walls extending longitudinally from the base portion 106 to the mouthpiece 107. In particular, the consumable component 102 comprises front 108a and rear walls spaced by opposing first 108c and second 108d side walls. The distance between the front 108a and rear 108b walls defines a depth of the housing 105 and the distance between the side walls 108c, 108d defines a width of the housing 105. The width of the housing 105 is greater than the depth of the housing 105.

The tank 103 of the consumable component 102 comprises a window 109, which allows the quantity of e-liquid remaining in the tank 103 to be visually assessed. The device 101 includes a slot 110 so that the window 109 of the consumable component 102 can be seen whilst the rest of the tank 103 is obscured from view when the consumable component 102 is inserted into the cavity at the upper end 108 of the device 101.

A lower end 111 of the device 101 includes a light 112 (e.g., an LED) located behind a small translucent cover. The light 112 may be configured to illuminate when the smoking substitute system 100 is activated. Whilst not shown, the consumable component 102 may identify itself to the device 101, via an electrical interface, RFID chip, or barcode.

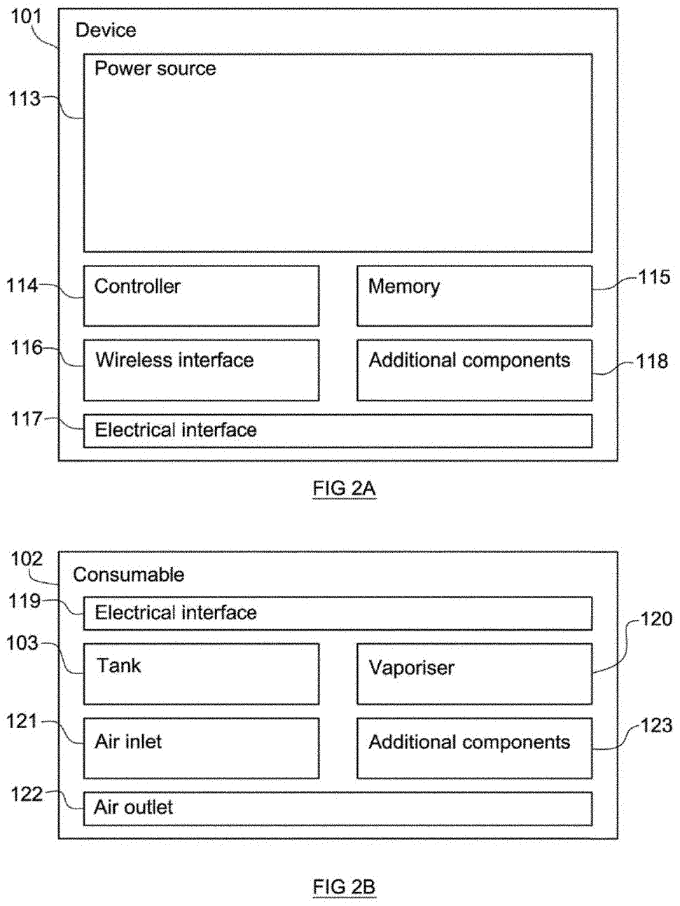

FIGS. 2A and 2B are schematic drawings of the device 101 and consumable component 102. These figures provide an overview of the components that form part of the consumable component 102 and device 101. As is apparent from FIG. 2A, the device 101 includes a power source 113, a controller 114, a memory 115, a wireless interface 116, an electrical interface 117, and, optionally, one or more additional components 118.

The power source 113 is a battery (e.g., a rechargeable battery). The controller 114 may, for example, include a microprocessor. The memory 115 may include non-volatile memory. The memory 115 may include instructions which, when implemented, cause the controller 114 to perform certain tasks or steps of a method.

The wireless interface 116 may be configured to communicate wirelessly with another device, for example a mobile device, e.g., via Bluetooth®. To this end, the wireless interface 116 could include a Bluetooth® antenna. Other wireless communication interfaces, e.g., WIFI®, are also possible. The wireless interface 116 may also be configured to communicate wirelessly with a remote server.

The electrical interface 117 of the device 101 may include one or more electrical contacts. The electrical interface 117 may be located in a base of the cavity formed in the upper end 104 of the device 101. When the device 101 is physically coupled to the consumable component 102, the electrical interface 117 of the device 101 is configured to transfer electrical power from the power source 113 to the consumable component 102 (i.e., upon activation of the smoking substitute system 100).

The electrical interface 117 may be configured to receive power from a charging station when the device 101 is not physically coupled to the consumable component 102 and is instead coupled to the charging station. The electrical interface 117 may also be used to identify the consumable component 102 from a list of known consumables. For example, the consumable component 102 may include e-liquid having a particular flavor and/or having a certain concentration of nicotine (which may be identified by the electrical interface 117). This can be indicated to the controller 114 of the device 101 when the consumable component 102 is connected to the device 101. Additionally, or alternatively, there may be a separate communication interface provided in the device 101 and a corresponding communication interface in the consumable component 102 such that, when connected, the consumable component 102 can identify itself to the device 101.

The additional components 118 of the device 101 may comprise an indicator (e.g., the light 112 discussed above), a charging portion, a battery charging control circuit, a sensor or, e.g., user input.

The charging port (e.g., USB or micro-USB port) may be configured to receive power from the charging station (i.e., when the power source 118 is a rechargeable battery). This may be located at the lower end 111 of the device 101. Alternatively, the electrical interface 117 discussed above may be configured to act as a charging port configured to receive power from the charging station such that a separate charging port is not required.

The battery charging control circuit may be configured for controlling the charging of the rechargeable battery. However, a battery charging control circuit could equally be located in the charging station (if present).

The sensor may be, e.g., an airflow (i.e., puff) sensor for detecting airflow in the smoking substitute system 100, e.g., caused by a user inhaling through a mouthpiece 107 of the consumable component 102. The smoking substitute system 100 may be configured to be activated when airflow is detected by the airflow sensor. This sensor could alternatively be included in the consumable component 102. The airflow sensor can be used to determine, for example, how heavily a user draws on the mouthpiece 107 or how many times a user draws on the mouthpiece 107 in a particular time period.

The user input may be a button. The smoking substitute system 100 may be configured to be activated when a user interacts with the user input (e.g., presses the button). This provides an alternative to the airflow sensor as a mechanism for activating the smoking substitute system 100.

The consumable component 102, which is shown in FIG. 2B, includes the tank 103, an electrical interface 119, a vaporizer 120, an air inlet 121, an air outlet 122 (e.g., formed in the mouthpiece 107), and one or more additional components 123.

The electrical interface 119 of the consumable component 102 may include one or more electrical contacts. The electrical interface 117 of the device 101 and the electrical interface 119 of the consumable component 102 may be configured to contact each other and thereby electrically couple the device 101 to the consumable component 102 when the base portion 106 of the consumable component 102 is inserted into the cavity formed in the upper end 104 of the device 101 (as shown in FIG. 1A). In this way, electrical energy (e.g., in the form of an electrical current) is able to be supplied from the power source 113 in the device 101 to the vaporizer 120 in the consumable component 102.

The vaporizer 120 is configured to heat and vaporize e-liquid contained in the tank 103 using electrical energy supplied from the power source 113. As will be described further below, the vaporizer 120 heats the e-liquid received from the tank 103 to vaporize the e- liquid. The air inlet 121 is configured to allow air to be drawn into the smoking substitute system 100 when a user inhales using the air outlet 122 formed in the mouthpiece 107, such that the vaporized e-liquid is drawn through the consumable component 102 for inhalation by the user.

In operation, a user activates the smoking substitute system 100, e.g., through interaction with a user input forming part of the device 101 or by inhaling through the air outlet 122 as described above. Upon activation, the controller 114 may supply electrical energy from the power source 113 to the vaporizer 120 (via electrical interfaces 117, 119), which may cause the vaporizer 120 to heat e-liquid drawn from the tank 103 to produce a vapor which is inhaled by a user through the mouthpiece 107.

An example of one of the one or more additional components 123 of the consumable component 102 is an interface for obtaining an identifier of the consumable component 102. As discussed above, this interface may be, for example, an RFID reader, a barcode, a QR code reader, or an electronic interface which is able to identify the consumable component 102. The consumable component 102 may, therefore include any one or more of an RFID chip, a barcode or QR code, or memory within which is an identifier and which can be interrogated via the electronic interface 117 in the device 101.

It should be appreciated that the smoking substitute system 100 shown in FIGS. 1A to 2B is just one exemplary implementation of a smoking substitute system 100. For example, the system could otherwise be in the form of an entirely disposable (single-use) system or an open system in which the tank is refillable (rather than replaceable).

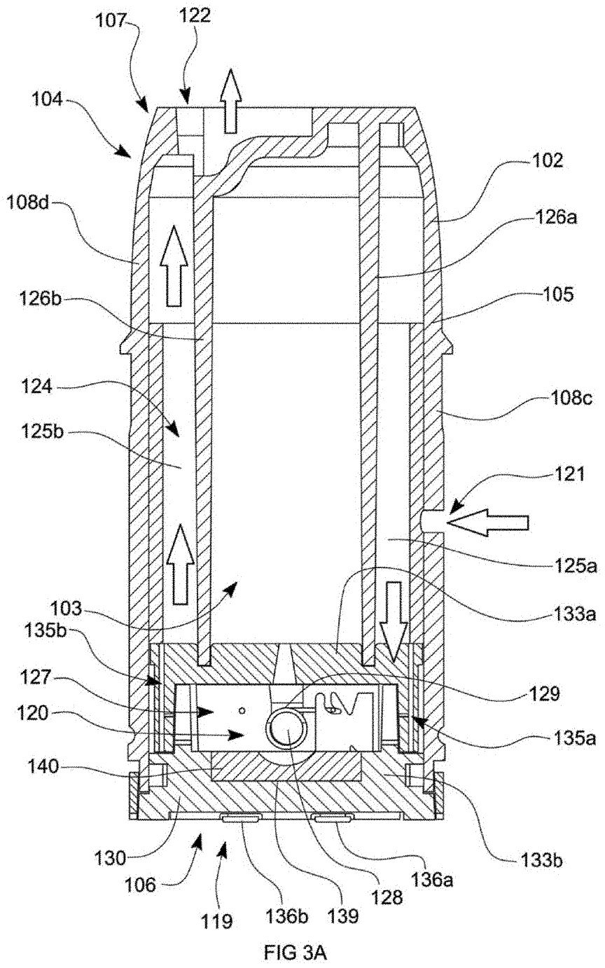

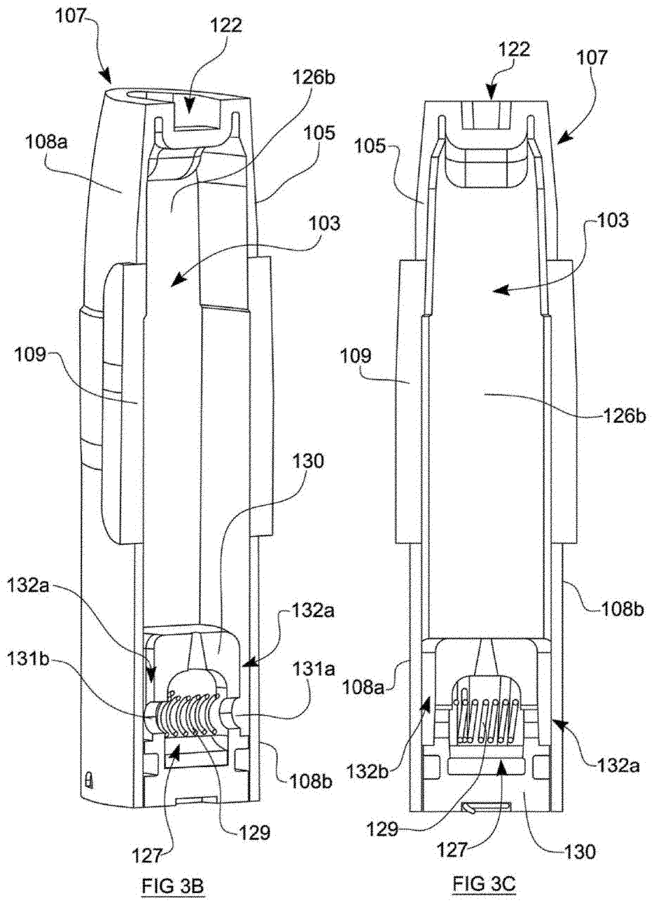

FIGS. 3A, 3B and 3C are section views of the consumable component 102 described above. The air inlet 121 of the consumable component 102 is in the form of an aperture formed in the first side wall 108c of the housing 105. In particular, the air inlet 121 is spaced along the first side wall 108c (in a longitudinal direction) from the base portion 106 of the housing 105 so as to be partway along the first side wall 108c from the base portion 106. The air outlet 122 is formed in the mouthpiece 107 and an airflow path 124 extends from the air inlet 121 to the air outlet 122, such that a user can draw air through the airflow path 124 by inhaling at the air outlet 122. As will be described in more detail below, the airflow path 124 follows a generally U-shaped path through the consumable component 102.

The airflow path 124 comprises first 138a, second and third 138c airflow path portions. The first airflow path portion is defined by an inlet passage 125a extending longitudinally from the air inlet 121 towards the base portion 106 of the consumable component 102. This inlet passage 125a is defined between a first tank wall 126a that is laterally (i.e., transversely) spaced from the first side wall 108c (in which the air inlet 121 is formed) and that extends longitudinally from an internal surface of the mouthpiece 107.

The third airflow path is similarly defined by an outlet passage 125b that is formed between a second tank wall 126b and the second side wall 108d. The second tank wall 126b extends longitudinally from an internal surface of the mouthpiece 107 and is laterally spaced from the second side wall 108d. Both the first 126a and second 126b tank walls span the front 108a and rear 108b (see FIG. 3B) walls of the housing 105. In this way, the tank 103 is partly defined between the first and second tank walls 126a, 126b, the front 108a and rear 108b walls, and an internal surface of the mouthpiece 107.

The tank walls 126a, 126b and the mouthpiece 107 are integrally formed with each other so as to form a single unitary component that may, e.g., be formed by way of an injection molding process. Such a component may be formed of a thermoplastic material such as polypropylene. To facilitate this (e.g., to allow removal from a mold), each of the tank walls 126a, 126b is tapered from a proximal end at which it is connected to the mouthpiece 107 to an opposing distal end.

The second airflow path portion is in the form of a vaporizing chamber 127 that extends transversely across the housing 105 so as to connect lower ends of the first 125a and second 125b passages. Thus, upon inhalation by a user, air may flow into the inlet 121, through the inlet passage 125a, through the vaporizing chamber 127 (where vapor may be entrained in the air) and subsequently through the outlet passage 125b where it is discharged (into a user's mouth) from the outlet 122 at an upper end of the outlet passage 125b. Thus, the airflow path 124 comprises at least two turns (at the inlet 121 and the connection between the vaporizing chamber 127 and the inlet passage 125a) between the vaporizer chamber 127 and the inlet 121. This may reduce the propensity for leakage of e-liquid out of the inlet 121 (i.e., from the vaporizing chamber 127).

The vaporizer 120 is located in the vaporizing chamber 127 and comprises a porous wick 128 and a heater filament 129 coiled around the porous wick 128. The wick 128 extends across the vaporizing chamber 127 (perpendicular to the direction of airflow through the chamber 127). That is, the wick 128 extends in the depth direction of the housing 105.

The vaporizing chamber 127 is formed within a base member 130 that is received in an open lower end of the housing 105 so as to define the base portion 106 of the consumable component 102. The base member 130 seals against the walls of the housing 105 so as to define a lower end of the tank 103. Thus, the walls of the base member 130 (defining the vaporizing chamber 127) separate the vaporizing chamber 127 from the tank 103. In particular, an upper transverse wall 133a of the base member 130 spans the first tank wall 126a and the second tank wall 126b so as to separate the vaporizing chamber 127 from the tank 103 (and so as to define a lower surface of the tank 103).

The base member 130 also includes a lower transverse wall 133b which is longitudinally spaced from the upper transverse wall 133a. The vaporizing chamber 127 is formed between the lower transverse wall 133b and the upper transverse wall 133a. The lower transverse wall 133b includes a recess 139 which houses a sealing element 140.

To form a seal with the tank walls 126a, 126b, the upper wall comprises grooves 134a, 134b that extend in a direction of the depth of the housing 105 and receive distal ends of the tank walls 126a, 126b. This arrangement also seals the tank 103 from the air passages 125a, 125b, which connect to the vaporizing chamber 127 via respective channels 135a, 135b formed in the base member 130.

As shown in FIG. 3B, the front and rear walls of the vaporizing chamber 127 comprises two apertures 131a, 131b formed in opposing front and rear walls of the base member 130 for receipt of respective ends of the wick 128 therethrough. The base member 130 is spaced from each of the front 108a and rear 108b walls of the housing, such that gaps 132a, 132b are formed between the base member 130 and each of the front 108a and rear 108b housing walls. These gaps 132a, 132b are arranged such that the ends of the wick 128 projecting through the apertures 131a, 131b in the base member 134 are received in the gaps 132a, 132b. In this way, the ends of the wick 128 are in contact with aerosol precursor (e- liquid) stored in the tank 103. This e-liquid is transported along the wick 128 (e.g., by capillary action) to a central portion of the wick 128 that is exposed to airflow flowing through the vaporizing chamber 127. The transported e-liquid is heated by the heater filament 129 (when activated, e.g., by detection of inhalation), which causes the e-liquid to be vaporized and to be entrained in air flowing across the wick 128. This vaporized liquid may cool to form an aerosol in the passage 140, which may then be inhaled by a user.

The base member also 130 accommodates the electrical interface 119 of the consumable component 102. The electrical interface 119 comprises two electrical contacts 136a, 136b that are electrically connected to the heater filament 129. When the consumable component 102 is engaged with the device 101, power can be supplied from the power source 113 of the device to the heater filament 129. Electrical contacts 136a, 136b have different polarities (i.e., one is a positive contact and the other is a negative contact), so as to facilitate the flow of electrical current between the contacts 136a, 136b. The flow of current through the heating filament 129 heats up the filament 129, and thus electrical energy is partially converted to heat. This effect is used to heat up the aerosol precursor in the manner described above.

The lower transverse wall 133b further includes first and second base slots 137a, 137b which extend longitudinally through the lower transverse wall 133b to the recess 139.

The first and second base slots 137a, 137b are transversely elongated, i.e., in a direction perpendicular to the longitudinal axis of the component.

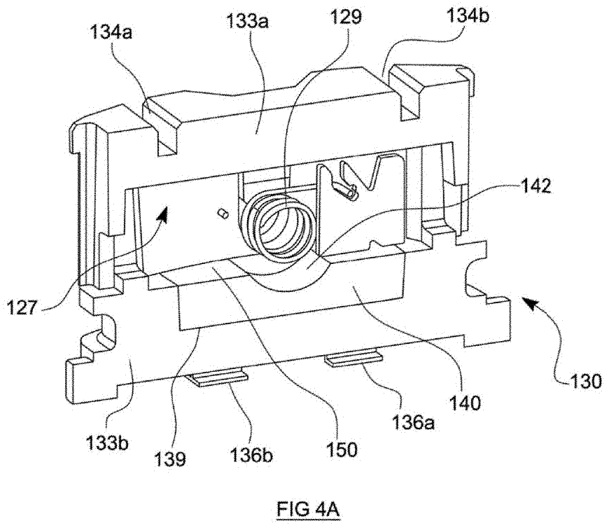

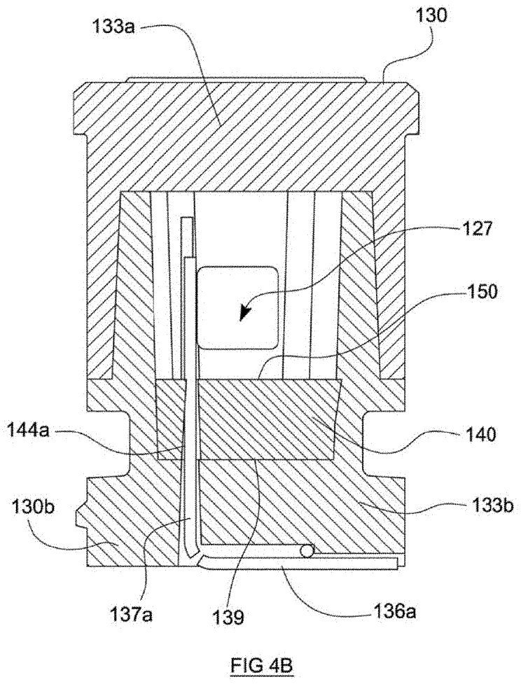

As shown in FIGS. 3A, 4A and 4B, the base member 130 accommodates the sealing element 140 within the recess 139 defined in the lower transverse wall 133b of the base member 130.

The sealing element 140 has a length, a width and a thickness. The sealing element 140 may be substantially cuboid. The thickness of the sealing element extends along the longitudinal axis of the consumable component 102. The cross-sectional area of the sealing element 140 in the transverse plane is substantially rectangular.

The sealing element 140 has an upper surface, a bottom surface, and a side surface. The upper surface 150 faces the vaporizing chamber 127 and so is exposed to the airflow flowing through the vaporizing chamber 127. The upper surface 150 includes an elongate channel 142 for at least partly receiving the heater filament 129. The elongate channel 142 extends across the width of the sealing element 140 and has a shape, which corresponds to the shape of the heater filament 129. In the illustrated example, that shape is semi-cylindrical. In this way, the channel 142 extends between the front and rear walls of the vaporizing chamber 127.

The sealing element 140 is seated within (and fills) the recess 139, such that the bottom surface and the side surface of the sealing element 140 engage with the recess 139. The upper surface 150 is flush with the lower transverse wall 133b, such that the upper surface 150 at least partly defines the vaporizing chamber 127.

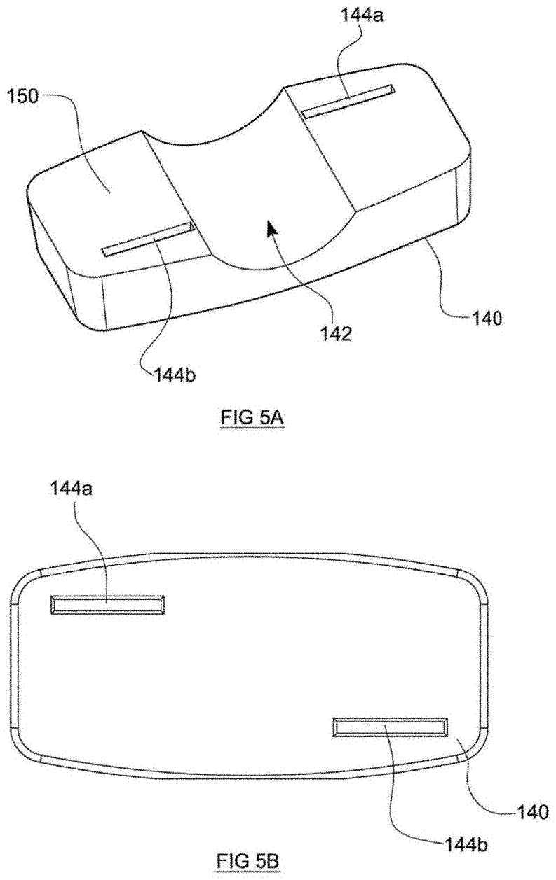

As shown in FIGS. 5A and 5B, the sealing element 140 includes a pair of seal slots 144a and 144b extending through the thickness of the sealing element 140. Each seal slot 144a, 144b has a substantially rectangular transverse cross-section and slot opening, which corresponds to the shape of the electrical contacts 136a, 136b, although other suitable cross sections—such as circular—are also possible. The seal slots 144a are disposed at diagonally opposite ends of the sealing element 140, although they can also be disposed in line with each other, or in any other suitable configuration. The arrangement and the shape of the seal slots 144a, 144b corresponds to that of the base slots 137a, 137b such that the seal slots 144a, 144b and the base slots 137a, 137b are arranged in the same position in the transverse plane and have the same transverse cross-sectional profile.

The electrical contacts 136a, 136b extend through the base member 130 and into the vaporizing chamber 127 via their corresponding base slots 137a, 137b and seal slots 144a, 144b. Thus, the sealing element 140 directly engages both electrical contacts 136a, 136b, such that the seal 140 seals between the electrical contacts 136a, 136b and the base member 130, thus preventing leakage of fluids from the vaporizing chamber 127 or ingress of moisture through the base slots 137a, 137b.

Second Mode: Wireless charger for a smoking substitute device

Aspects and embodiments of the second mode of the present disclosure will now be discussed with reference to the accompanying figures. Further aspects and embodiments will be apparent to those skilled in the art. All documents mentioned in this text are incorporated herein by reference.

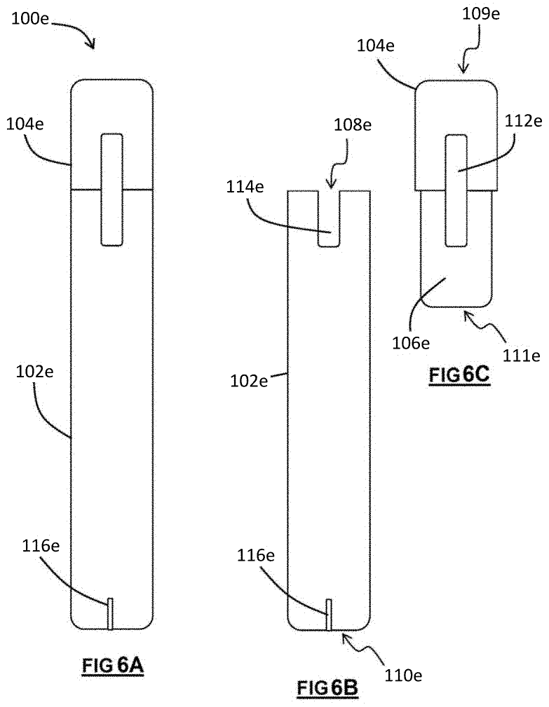

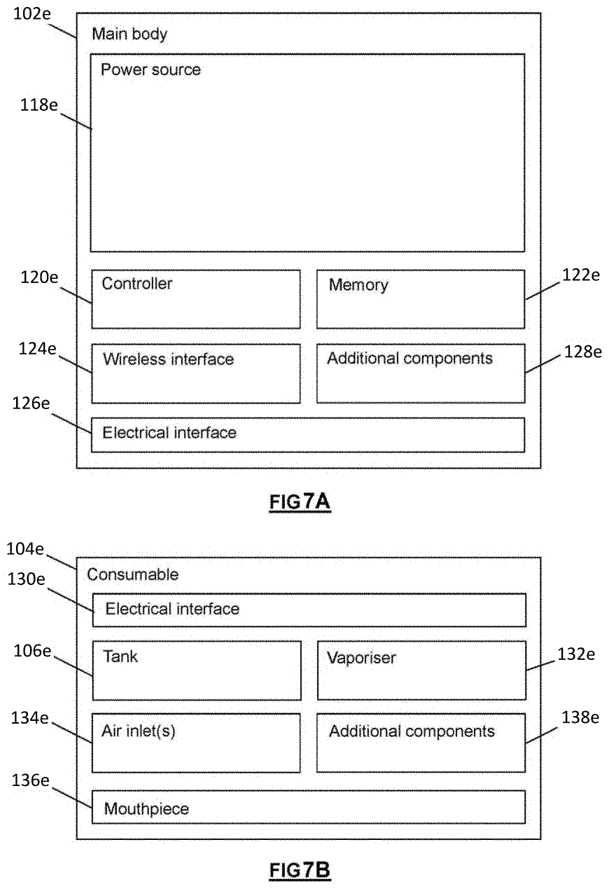

FIG. 6A shows a first embodiment of a smoking substitute system 100e. In this example, the smoking substitute system 100e includes a main body 102e and an aerosol delivery device in the form of a consumable 104e. The consumable 104e may alternatively be referred to as a “pod”, “cartridge” or “cartomizer”. It should be appreciated that in other examples (i.e., open systems), the main body may be integral with the consumable such that the aerosol delivery device incorporates the main body. In such systems, a tank of the aerosol delivery device may be accessible for refilling the device.

In this example, the smoking substitute system 100e is a closed system vaping system, wherein the consumable 104e includes a sealed tank 106e and is intended for single-use only. The consumable 104e is removably engageable with the main body 102e (i.e., for removal and replacement). FIG. 6A shows the smoking substitute device 100e with the main body 102e physically coupled to the consumable 104e, FIG. 6B shows the main body 102e of the smoking substitute system 100e without the consumable 104e, and FIG. 6C shows the consumable 104e of the smoking substitute system 100e without the main body 102e.

The main body 102e and the consumable 104e are configured to be physically coupled together by pushing the consumable 104e into a cavity at an upper end 108e of the main body 102e, such that there is an interference fit between the main body 102e and the consumable 104e. In other examples, the main body 102e and the consumable may be coupled by screwing one onto the other, or through a bayonet fitting.

The consumable 104e includes a mouthpiece (not shown in FIG. 6A, 6B or 6C) at an upper end 109e of the consumable 104e, and one or more air inlets (not shown) in fluid communication with the mouthpiece such that air can be drawn into and through the consumable 104e when a user inhales through the mouthpiece. The tank 106e containing e- liquid is located at the lower end 111e of the consumable 104e.

The tank 106e includes a window 112e, which allows the amount of e-liquid in the tank 106e to be visually assessed. The main body 102e includes a slot 114e so that the window 112e of the consumable 104e can be seen whilst the rest of the tank 106e is obscured from view when the consumable 104e is inserted into the cavity at the upper end 108e of the main body 102e.

The lower end 110e of the main body 102e also includes a light 116e (e.g., an LED) located behind a small translucent cover. The light 116e may be configured to illuminate when the smoking substitute system 100e is activated. Whilst not shown, the consumable 104e may identify itself to the main body 102e, via an electrical interface, RFID chip, or barcode.

FIG. 7A and FIG. 7B are schematic drawings of the main body 102e and consumable 104e. As is apparent from FIG. 7A, the main body 102e includes a power source 118e, a controller 120e, a memory 122e, a wireless interface 124e, an electrical interface 126e, and, optionally, one or more additional components 128e.

The power source 118e is preferably a battery, more preferably a rechargeable battery. The controller 120e may include a microprocessor, for example. The memory 122e preferably includes non-volatile memory. The memory may include instructions which, when implemented, cause the controller 120e to perform certain tasks or steps of a method.

The wireless interface 124e is preferably configured to communicate wirelessly with another device, for example a mobile device, e.g., via Bluetooth®. To this end, the wireless interface 124e could include a Bluetooth® antenna. Other wireless communication interfaces, e.g., WIFI®, are also possible. The wireless interface 124e may also be configured to communicate wirelessly with a remote server.

The electrical interface 126e of the main body 102e may include one or more electrical contacts. The electrical interface 126e may be located in a base of the aperture in the upper end 108e of the main body 102e. When the main body 102e is physically coupled to the consumable 104e, the electrical interface 126e is configured to transfer electrical power from the power source 118e to the consumable 104e (i.e., upon activation of the smoking substitute system 100e).

The electrical interface 126e may be configured to receive power from a charging station when the main body 102e is not physically coupled to the consumable 104e and is instead coupled to the charging station. The electrical interface 126e may also be used to identify the consumable 104e from a list of known consumables. For example, the consumable 104e may be a particular flavor and/or have a certain concentration of nicotine (which may be identified by the electrical interface 126e). This can be indicated to the controller 120e of the main body 102e when the consumable 104e is connected to the main body 102e. Additionally, or alternatively, there may be a separate communication interface provided in the main body 102e and a corresponding communication interface in the consumable 104e such that, when connected, the consumable 104e can identify itself to the main body 102e.

The additional components 128e of the main body 102e may comprise the light 116e discussed above.

The additional components 128e of the main body 102e may also comprise a charging port (e.g., USB or micro-USB port) configured to receive power from the charging station (i.e., when the power source 118e is a rechargeable battery). This may be located at the lower end 110e of the main body 102e. Alternatively, the electrical interface 126e discussed above may be configured to act as a charging port configured to receive power from the charging station such that a separate charging port is not required.

The additional components 128e of the main body 102e may, if the power source 118e is a rechargeable battery, include a battery charging control circuit, for controlling the charging of the rechargeable battery. However, a battery charging control circuit could equally be located in the charging station (if present).

The additional components 128e of the main body 102e may include a sensor, such as an airflow (i.e., puff) sensor for detecting airflow in the smoking substitute system 100e, e.g., caused by a user inhaling through a mouthpiece 136e of the consumable 104e. The smoking substitute system 100e may be configured to be activated when airflow is detected by the airflow sensor. This sensor could alternatively be included in the consumable 104e. The airflow sensor can be used to determine, for example, how heavily a user draws on the mouthpiece or how many times a user draws on the mouthpiece in a particular time period.

The additional components 128e of the main body 102e may include a user input, e.g., a button. The smoking substitute system 100e may be configured to be activated when a user interacts with the user input (e.g., presses the button). This provides an alternative to the airflow sensor as a mechanism for activating the smoking substitute system 100e.

As shown in FIG. 7B, the consumable 104e includes the tank 106e, an electrical interface 130e, a vaporizer 132e, one or more air inlets 134e, a mouthpiece 136e, and one or more additional components 138e.

The electrical interface 130e of the consumable 104e may include one or more electrical contacts. The electrical interface 126e of the main body 102e and an electrical interface 130e of the consumable 104e are configured to contact each other and thereby electrically couple the main body 102e to the consumable 104e when the lower end 111e of the consumable 104e is inserted into the upper end 108e of the main body 102e (as shown in FIG. 6A). In this way, electrical energy (e.g., in the form of an electrical current) is able to be supplied from the power source 118e in the main body 102e to the vaporizer 132e in the consumable 104e.

The vaporizer 132e is configured to heat and vaporize e-liquid contained in the tank 106e using electrical energy supplied from the power source 118e. As will be described further below, the vaporizer 132e includes a heating filament and a wick. The wick draws e- liquid from the tank 106e and the heating filament heats the e-liquid to vaporize the e-liquid.

The one or more air inlets 134e are preferably configured to allow air to be drawn into the smoking substitute system 100e, when a user inhales through the mouthpiece 136e. When the consumable 104e is physically coupled to the main body 102e, the air inlets 134e receive air, which flows to the air inlets 134e along a gap between the main body 102e and the lower end 111e of the consumable 104e.

In operation, a user activates the smoking substitute system 100e, e.g., through interaction with a user input forming part of the main body 102e or by inhaling through the mouthpiece 136e as described above. Upon activation, the controller 120e may supply electrical energy from the power source 118e to the vaporizer 132e (via electrical interfaces 126e, 130e), which may cause the vaporizer 132e to heat e-liquid drawn from the tank 106e to produce a vapor which is inhaled by a user through the mouthpiece 136e.

An example of one of the one or more additional components 138e of the consumable 104e is an interface for obtaining an identifier of the consumable 104e. As discussed above, this interface may be, for example, an RFID reader, a barcode, a QR code reader, or an electronic interface which is able to identify the consumable. The consumable 104e may, therefore include any one or more of an RFID chip, a barcode or QR code, or memory within which is an identifier and which can be interrogated via the electronic interface in the main body 102e.

It should be appreciated that the smoking substitute system 100e shown in FIG. 6A to FIG. 7B is just one exemplary implementation of a smoking substitute system. For example, the system could otherwise be in the form of an entirely disposable (single-use) system or an open system in which the tank is refillable (rather than replaceable).

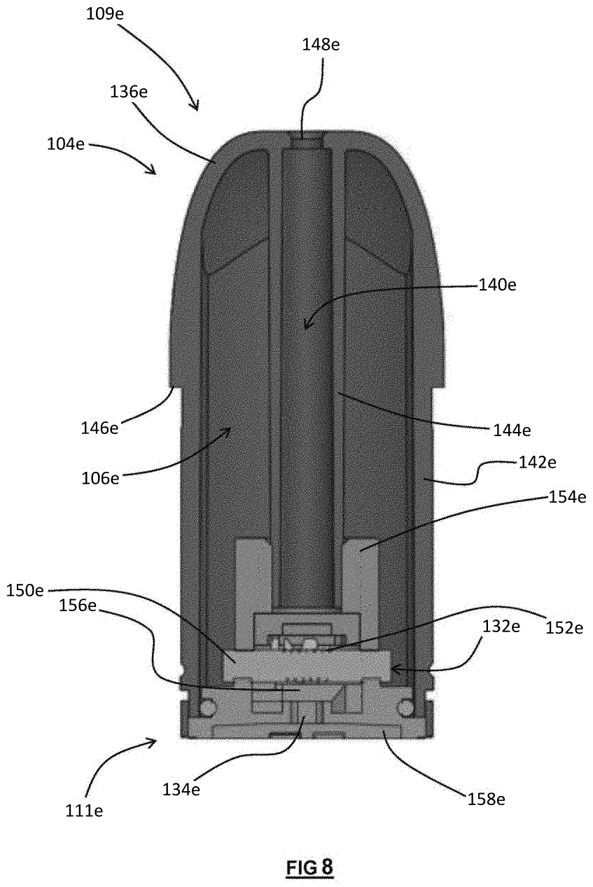

FIG. 8 is a section view of the consumable 104e described above. The consumable 104e comprises a tank 106e for storing e-liquid, a mouthpiece 136e and a passage 140e extending along a longitudinal axis of the consumable 104e. In the illustrated embodiment the passage 140e is in the form of a tube having a substantially circular transverse cross- section (i.e., transverse to the longitudinal axis). The tank 106e surrounds the passage 140e, such that the passage 140e extends centrally through the tank 106e.

A tank housing 142e of the tank 106e defines an outer casing of the consumable 104e, whilst a passage wall 144e defines the passage 140e. The tank housing 142e extends from the lower end 111e of the consumable 104e to the mouthpiece 136e at the upper end 109e of the consumable 104e. At the junction between the mouthpiece 136e and the tank housing 142e, the mouthpiece 136e is wider than the tank housing 142e, so as to define a lip 146e that overhangs the tank housing 142e. This lip 146e acts as a stop feature when the consumable 104e is inserted into the main body 102e (i.e., by contact with an upper edge of the main body 102e).

The tank 106e, the passage 140e and the mouthpiece 136e are integrally formed with each other so as to form a single unitary component and may, e.g., be formed by way of an injection molding process. Such a component may be formed of a thermoplastic material such as polypropylene.

The mouthpiece 136e comprises a mouthpiece aperture 148e defining an outlet of the passage 140e. The vaporizer 132e is fluidly connected to the mouthpiece aperture 148e and is located in a vaporizing chamber 156e of the consumable 104e. The vaporizing chamber 156e is downstream of the inlet 134e of the consumable 104e and is fluidly connected to the mouthpiece aperture 148e (i.e., outlet) by the passage 140e.

The vaporizer 132e comprises a porous wick 150e and a heater filament 152e coiled around the porous wick 150e. The wick 150e extends transversely across the chamber vaporizing 156e between sidewalls of the chamber 156e which form part of an inner sleeve 154e of an insert 158e that defines the lower end 111e of the consumable 104e that connects with the main body 102e. The insert 158e is inserted into an open lower end of the tank 106e so as to seal against the tank housing 142e.

In this way, the inner sleeve 154e projects into the tank 106e and seals with the passage 140e (around the passage wall 144e) so as to separate the vaporizing chamber 156e from the e-liquid in the tank 106e. Ends of the wick 150e project through apertures in the inner sleeve 154e and into the tank 106e so as to be in contact with the e-liquid in the tank 106e. In this way, e-liquid is transported along the wick 150e (e.g., by capillary action) to a central portion of the wick 150e that is exposed to airflow through the vaporizing chamber 156e. The transported e-liquid is heated by the heater filament 152e (when activated, e.g., by detection of inhalation), which causes the e-liquid to be vaporized and to be entrained in air flowing past the wick 150e. This vaporized liquid may cool to form an aerosol in the passage 140e, which may then be inhaled by a user.

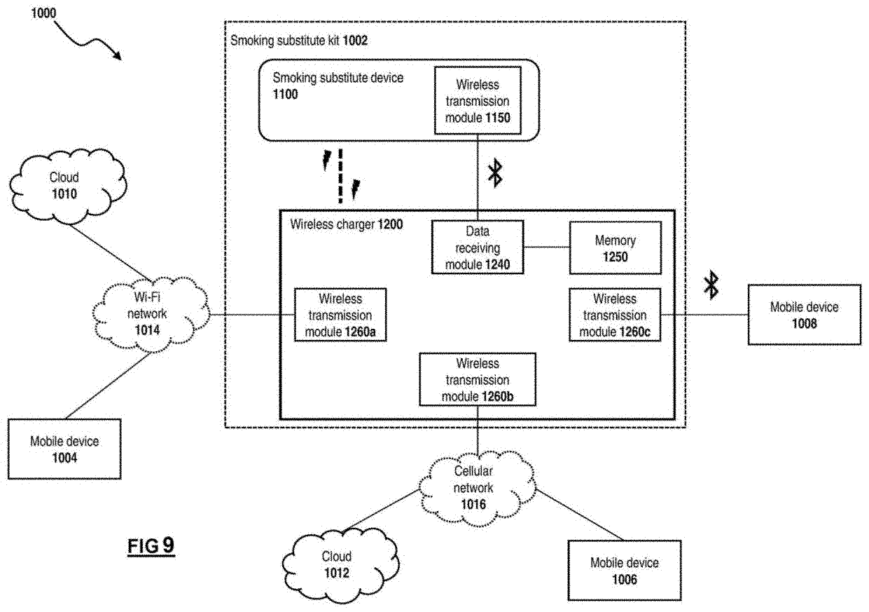

FIG. 9 is a system diagram of a smoking substitute system 1000 according to, e.g., an embodiment of a third aspect of the second mode. The system 1000 includes primarily a smoking substitute device 1100 and a wireless charger 1200, which together make up a smoking substitute kit 1002, according to an embodiment of, e.g., a second aspect of the second mode. It will be noted that the wireless charger 1200 is according to an embodiment of, e.g., a first aspect of the second mode. In FIG. 9, the solid connecting lines denote transfer of data, and the dashed connecting lines denote the transfer of power. The transfer of power between the smoking substitute device 1100 and the wireless charger 1200 may take place by electromagnetic induction effected by the alignment of a transmitter coil (not shown) in the wireless charger 1200 and a receiver coil (not shown) in the smoking substitute device 1100.

The smoking substitute device 1100 includes a wireless transmission module 1150. The wireless charger 1200 includes a data receiving module 1240, a memory 1250 connected to the data receiving module 1240, and wireless transmission modules 1260a, 1260b, 1260c. It must be stressed that wireless charges 1200a according to the second mode of the present disclosure need not include three wireless transmission modules 1260a, 1260b, 1260c. They may include any or all of these, and may optionally include additional wireless transmission modules (not shown) which may be connected to a similar set of components as any or all of wireless transmission modules 1260a, 1260b, 1260c. Alternatively, a single wireless transmission module may be configured to perform the function of more than one of the wireless transmission modules 1260a, 1260b, 1260c, and still fall within the scope of the second mode of the present disclosure.

In addition to the smoking substitute device 1100 and the wireless charger 1200, the system 1000 also includes a plurality of external locations or external devices. Specifically, the system 1000 includes mobile devices 1004, 1006, 1008, and cloud storage locations 1010, 1012. More specifically, cloud storage location 1010 and mobile device 1004 are connected to wireless transmission module 1260a via a Wi-Fi network 1014; cloud storage location 1012 and mobile device 1006 are connected to wireless transmission module 1260b via cellular network 1016; and mobile device 1008 is connected to wireless transmission module 1260c via a Bluetooth connection denoted by the Bluetooth logo.

The operation of system 1000 will now briefly be described. In a first step, the smoking substitute device 1100 may be placed on the wireless charger 1200, which may cause charging to begin. Alternatively, the wireless transmission module 1150 of the smoking substitute device 1100 may send a charge request which is received by the data receiving module 1240 of the wireless charger 1200. In response to that charge request, the wireless charger 1200 may begin the charging process. In addition to a charge request, the wireless transmission module 1150 of the smoking substitute device 1100 may further be configured to send other data to the wireless charger 1200, which is received by the data receiving module 1240. This data may include information about a charge status of the smoking substitute device 1100, and may include various other types of data, described elsewhere in this application.

The wireless charger 1200 may be able to transmit both the charge status information and other information to an external location, in this case, either a mobile device 1004, 1006, 1008, or a cloud storage location 1010, 1012. In some cases, wireless transmission module 1260a may be configured to transmit data including charge status information (and optionally, other information) to mobile device 1004 and cloud storage location 1010 via Wi-Fi network 1014. Alternatively, wireless transmission module 1260b may be configured to transmit data including charge status information (and optionally, other information) to mobile device 1006 and cloud storage location 1012 via cellular network 1016. Alternatively, wireless transmission module 1260c may be configured to transmit charge status information (and optionally, other information) to mobile device 1008 via a Bluetooth connection.

### Illustrative Embodiments

Illustrative embodiments are provided herein below. The Illustrative embodiments are provided as one of various embodiments and are meant to be exemplary, not exhaustive, embodiments of the modes herein disclosed.

First Mode: Aerosol-Delivery Component Having a Sealing Element Seals Between the Base Member and the Electrical Contact

Illustrative Embodiment 1. An aerosol-delivery component, comprising:
a vaporizer disposed in a vaporizing chamber;
an electrical contact for electrically connecting the vaporizer to a power supply, the contact extending through a base member of the component and into the vaporizing chamber; and
a sealing element configured to seal between the electrical contact and the base member.

Illustrative Embodiment 2. A component according to Illustrative Embodiment 1 wherein the base member accommodates the sealing element and the sealing element is configured to directly engage the electrical contact to seal between the electrical contact and the base member.

Illustrative Embodiment 3. A component according to Illustrative Embodiment 1 or 2 wherein the component further comprises a second electrical contact for electrically connecting the vaporizer to the power supply, the second contact extending through the base member of the component and into the vaporizing chamber, wherein the sealing element is configured to seal between the second electrical contact and the base member.

Illustrative Embodiment 4. A component according to any one of Illustrative Embodiments 1 to 3 wherein the base member comprises a base slot through which the electrical contact extends wherein the sealing element comprises a seal slot through which the electrical contact extends.

Illustrative Embodiment 5. A component according to Illustrative Embodiment 4 wherein the electrical contact extends through the base slot and seal slot in a direction aligned with a longitudinal axis of the component.

Illustrative Embodiment 6. A component according to Illustrative Embodiment 5 wherein the base slot and seal slot are transversely elongated in a direction perpendicular to the longitudinal axis of the component.

Illustrative Embodiment 7. A component according to any one of Illustrative Embodiments 4 to 6 wherein the base slot and seal slot are vertically aligned and, optionally.

Illustrative Embodiment 8. A component according to any one of Illustrative Embodiments 4 to 7 wherein the length and/or width of the seal slot in a plane perpendicular to the longitudinal axis of the component) is less than that of the base slot.

Illustrative Embodiment 9. A component according to any one of Illustrative Embodiments 4 to 8 wherein the base member comprises a lower transverse wall and the base slot is formed in the lower transverse wall.

Illustrative Embodiment 10. A component according to Illustrative Embodiment 9 wherein the lower transverse wall of the base member comprises a recess for housing the sealing element.

Illustrative Embodiment 11. A component according to Illustrative Embodiment 10 wherein an upper surface of the sealing element defines a lower transverse wall of the vaporizing chamber.

Illustrative Embodiment 12. A component according to Illustrative Embodiment 11 wherein the upper surface of the sealing element comprises an elongate channel.

Illustrative Embodiment 13. A component according to Illustrative Embodiment 12 wherein the channel extends between front and rear walls of the vaporizing chamber.

Illustrative Embodiment 14. A component according to any one of Illustrative Embodiments claim 12 or 13 wherein the vaporizer comprises a heating filament mounted on an elongate wick and the axis of the elongate wick is parallel to and vertically spaced above the channel.

Illustrative Embodiment 15. A component according to any one of the preceding Illustrative Embodiments wherein the component is a consumable component for receipt in a smoking substitute device.

Illustrative Embodiment 16. An aerosol delivery system, comprising: an aerosol delivery component as defined in any of the Illustrative Embodiments 1 to 14; and a device comprising a power supply.

Second Mode: Wireless Charger for a Smoking Substitute Device

Illustrative Embodiment 1. A wireless charger for a smoking substitute device, the wireless charger including:
a data receiving module configured to receive telemetry data from the smoking substitute device;
a wireless transmission module configured to transmit the telemetry data to an external location.

Illustrative Embodiment 2. A wireless charger according to Illustrative Embodiment 1, wherein: the data receiving module is configured to receive the telemetry data from the smoking substitute device via a Bluetooth connection.

Illustrative Embodiment 3. A wireless charger according to Illustrative Embodiment 1 or Illustrative Embodiment 2, wherein: the data receiving module is configured to receive a charging request from the smoking substitute device, and wherein the wireless charger is configured to begin charging the smoking substitute device in response to the receiving module receiving the charging request.

Illustrative Embodiment 4. A wireless charger according to any one of Illustrative Embodiments 1 to 3, wherein: the telemetry data includes data information about a charge status of the smoking substitute device, the information including one or more of: the amount of battery life remaining in the battery of the smoking substitute, an estimate of the amount of time until the battery of the smoking substitute device will be fully charged, an indication of whether the wireless charger is currently charging the smoking substitute device or not, and an indication that the battery is fully charged.

Illustrative Embodiment 5. A wireless charger according to any one of Illustrative Embodiments 1 to 4, wherein: the telemetry data received from the smoking substitute device includes information about the usage of the smoking substitute device.

Illustrative Embodiment 6. A wireless charger according to any one of Illustrative Embodiments 1 to 5, wherein: the wireless transmission module is configured to transmit data to the external location over one or more of: a Wi-Fi network or a cellular network.

Illustrative Embodiment 7. A wireless charger according to any one of Illustrative Embodiments 1 to 6, wherein: the external location is a cloud storage location, or a mobile device.

Illustrative Embodiment 8. A wireless charger according to Illustrative Embodiment 7, wherein:
the wireless transmission module is configured to transmit data to a mobile device; and
the data which is transmitted from the wireless transmission module of the wireless charger to the mobile device includes a trigger which is configured to cause the mobile device to generate and/or display a notification relating to the information.

Illustrative Embodiment 9. A wireless charger according to any one of Illustrative Embodiments 1 to 8, wherein: the data receiving module is configured only to receive data from the smoking substitute device when the smoking substitute device is being charged by the wireless charger.

Illustrative Embodiment 10. A smoking substitute kit including:
a smoking substitute device, and
a wireless charger according to any one of Illustrative Embodiments 1 to 9, wherein:
the wireless charger is configured to charge the smoking substitute device when the smoking substitute device is in proximity to the wireless charger.

Illustrative Embodiment 11. A kit according to Illustrative Embodiment 10, wherein: the smoking substitute device includes a wireless transmission module configured to transmit telemetry data to the data receiving module of the wireless charger.

Illustrative Embodiment 12. A kit according to Illustrative Embodiment 11, wherein: the wireless transmission module of the smoking substitute device is configured to transmit information about the charge status of the smoking substitute device.

Illustrative Embodiment 13. A kit according to Illustrative Embodiment 12, wherein: the information about the charge status of the smoking substitute device includes one or more of: the information about a charge status includes one or more of: the amount of battery life remaining in the battery of the smoking substitute, an estimate of the amount of time until the battery of the smoking substitute device will be fully charged, an indication of whether the wireless charger is currently charging the smoking substitute device or not, and an indication that the battery is fully charged.

Illustrative Embodiment 14. A kit according to any one of Illustrative Embodiments 11 to 13, wherein: the telemetry data includes information about the usage of the smoking substitute device.

Illustrative Embodiment 15. A kit according to any one of Illustrative Embodiments 10 to 14, wherein: the wireless transmission module of the smoking substitute device is configured only to transmit data to the data receiving module of the wireless charger when the smoking substitute device is being charged by the wireless charger.

The features disclosed in the foregoing description, or in the illustrative embodiments, or in the following claims, or in the accompanying drawings, expressed in their specific forms or in terms of a means for performing the disclosed function, or a method or process for obtaining the disclosed results, as appropriate, may, separately, or in any combination of such features, be utilized for realizing the disclosure in diverse forms thereof.

While exemplary embodiments have been described above, many equivalent modifications and variations will be apparent to those skilled in the art when given this disclosure. Accordingly, the exemplary embodiments set forth above are considered to be illustrative and not limiting. Various changes to the described embodiments may be made without departing from the spirit and scope of the disclosure.

For the avoidance of any doubt, any theoretical explanations provided herein are provided for the purposes of improving the understanding of a reader. The inventors do not wish to be bound by any of these theoretical explanations.

Any section headings used herein are for organizational purposes only and are not to be construed as limiting the subject matter described.

Throughout this specification, including the claims which follow, unless the context requires otherwise, the words “have”, “comprise”, and “include”, and variations such as “having”, “comprises”, “comprising”, and “including” will be understood to imply the inclusion of a stated integer or step or group of integers or steps but not the exclusion of any other integer or step or group of integers or steps.

It must be noted that, as used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by the use of the antecedent “about,” it will be understood that the particular value forms another embodiment. The term “about” in relation to a numerical value is optional and means, for example, +/−10%.

The words “preferred” and “preferably” are used herein refer to embodiments of the disclosure that may provide certain benefits under some circumstances. It is to be appreciated, however, that other embodiments may also be preferred under the same or different circumstances. The recitation of one or more preferred embodiments therefore does not mean or imply that other embodiments are not useful, and is not intended to exclude other embodiments from the scope of the disclosure, or from the scope of the claims.

What is claimed is:

1. An aerosol-delivery component, comprising:
a vaporizer disposed in a vaporizing chamber;
an electrical contact for electrically connecting the vaporizer to a power supply, the contact extending through a base member of the component and into the vaporizing chamber; and
a sealing element configured to seal between the electrical contact and the base member.

2. A component according to claim 1 wherein the base member accommodates the sealing element and the sealing element is configured to directly engage the electrical contact to seal between the electrical contact and the base member.

3. A component according to claim 1 or 2 wherein the component further comprises a second electrical contact for electrically connecting the vaporizer to the power supply, the second contact extending through the base member of the component and into the vaporizing chamber, wherein the sealing element is configured to seal between the second electrical contact and the base member.

4. A component according to any one of claims 1 to 3 wherein the base member comprises a base slot through which the electrical contact extends wherein the sealing element comprises a seal slot through which the electrical contact extends.

5. A component according to claim 4 wherein the electrical contact extends through the base slot and seal slot in a direction aligned with a longitudinal axis of the component.

6. A component according to claim 5 wherein the base slot and seal slot are transversely elongated in a direction perpendicular to the longitudinal axis of the component.

7. A component according to any one of claims 4 to 6 wherein the base slot and seal slot are vertically aligned and, optionally.

8. A component according to any one of claims 4 to 7 wherein the length and/or width of the seal slot in a plane perpendicular to the longitudinal axis of the component) is less than that of the base slot.

9. A component according to any one of claims 4 to 8 wherein the base member comprises a lower transverse wall and the base slot is formed in the lower transverse wall.

10. A component according to claim 9 wherein the lower transverse wall of the base member comprises a recess for housing the sealing element.

11. A component according to claim 10 wherein an upper surface of the sealing element defines a lower transverse wall of the vaporizing chamber.

12. A component according to claim 11 wherein the upper surface of the sealing element comprises an elongate channel.

13. A component according to claim 12 wherein the channel extends between front and rear walls of the vaporizing chamber.

14. A component according to any one of claim 12 or 13 wherein the vaporizer comprises a heating filament mounted on an elongate wick and the axis of the elongate wick is parallel to and vertically spaced above the channel.

15. A component according to any one of the preceding claims wherein the component is a consumable component for receipt in a smoking substitute device.

16. An aerosol delivery system, comprising: an aerosol delivery component as defined in any of the claims 1 to 14; and a device comprising a power supply.

17. A wireless charger for a smoking substitute device, the wireless charger including:
a data receiving module configured to receive telemetry data from the smoking substitute device; and
a wireless transmission module configured to transmit the telemetry data to an external location.
